(19) United States
(12) Patent Application Publication
(10) Pub. No.: US 2026/0264338 A1
(43) Pub. Date: Sep. 10, 2026

(54) WORKPIECE CARRIER AND APPARATUS FOR PRODUCING THREE-DIMENSIONAL SCREEN-PRINTED WORKPIECES

(71) Applicant: Exentis Knowledge GmbH, Stetten Ag (CH)

(72) Inventors: Michael Reichenbach, Waldkirch (DE); Uwe Bürklin, Emmendingen (DE)

(21) Appl. No.: 19/164,117

(22) PCT Filed: Mar. 3, 2024
(86) PCT No.: PCT/EP2024/055523

§ 371 Date: Sep. 10, 2025

(30) Foreign Application Priority Data
Mar. 11, 2023 (DE) 20 2023 101 178.0
Mar. 11, 2023 (DE) 20 2023 101 179.9
Mar. 11, 2023 (DE) 20 2023 101 180.2
Mar. 11, 2023 (EP) 23161355.5
Mar. 11, 2023 (EP) 23161356.3
Mar. 11, 2023 (EP) 23161357.1
Jun. 11, 2023 (DE) 20 2023 103 189.7
Jun. 11, 2023 (EP) 23178564.3

(51) Int. Cl. B29C 64/40; B29C 64/112; B29C 64/245; B33Y 10/00; B33Y 30/00; B33Y 80/00

(52) U.S. Cl. CPC B29C 64/40; B29C 64/112; B29C 64/245; B33Y 10/00; B33Y 30/00; B33Y 80/00

(57) ABSTRACT

Workpiece carrier, in particular for the production of three-dimensional screen-printed workpieces, having at least one printing bed which has a printing surface to be printed on, and having a support structure which supports the printing bed and is formed separately from the printing bed, wherein the support structure has a support base and at least one stop for the printing bed, wherein the printing bed is arranged on the support base, and wherein, in the position arranged on the support base, the printing bed can be brought to bear against the stop in at least one lateral direction.

The present invention relates to a workpiece carrier, in particular for producing three-dimensional screen-printed workpieces. The present invention likewise relates to a support structure for such a workpiece carrier and to a conveying vehicle having such a workpiece carrier. Finally, the invention also relates to a device for producing three-dimensional screen-printed workpieces having such a workpiece carrier. The present invention likewise relates to a method for producing a three-dimensional screen-printed workpiece, to the use of a workpiece carrier and to a pharmaceutical product produced using such a workpiece carrier.

Workpiece carriers are used in a known manner for producing three-dimensional screen-printed workpieces. For example, a device for producing three-dimensional screen-printed workpieces in which a plurality of workpiece carriers are moved between a printing device and further stations of the device is known from the prior art in document EP 3725523 A1. Screen-printed workpieces can be constructed layerwise on the workpiece carriers in a plurality of printing operations, namely by printing a plurality of layers by way of three-dimensional screen printing.

The workpieces to be printed thus come into contact with the respective workpiece carrier or the respective printing surface of the workpiece carrier in the course of production. For this reason, there may be the requirement to select a suitable material for the workpiece carrier or to undertake the more detailed configuration of the workpiece carrier with regard to the workpieces to be produced or materials to be printed in each case. This can result in a relatively high cost effort for producing the respective workpiece carriers. In addition, the flexibility of use of workpiece carriers produced in a manner adapted in this way is limited. The use for other conditions of use or for producing screen-printed workpieces from other materials can take place only to a limited extent-if at all.

Finally, the configuration or adaptation of the workpiece carrier with regard to the screen-printed workpiece to be produced in each case or to the material of the screen-printed workpiece to be printed in each case can have disadvantageous effects on process-technical sequences in three-dimensional screen printing. Depending on the selected material for the workpiece carrier, the latter can have only a limited stability and therefore handling can be undertaken only with great effort.

Against the background set out above, the object of the present invention was to specify a workpiece carrier which can be produced with reduced cost effort, permits a suitable adaptability or configuration for the screen-printed workpieces to be produced in each case and ensures a high degree of flexibility of use and handleability.

Likewise, the object was to specify a support structure for such a workpiece carrier, a conveyor vehicle with a workpiece carrier and also a device for producing three-dimensional screen-printed workpieces. Finally, the object was also to specify a method for producing a three-dimensional screen-printed workpiece, the use of a workpiece carrier and a pharmaceutical product.

With regard to the workpiece carrier, this object has been achieved by the subject matter of claim 1 and also by the subject matters of claims 73 and 74. A support structure for such a workpiece carrier is specified in claim 75 and a conveying vehicle with such a workpiece carrier is specified in claim 76. A device for producing three-dimensional screen-printed workpieces is the subject matter of claim 77. A method for producing a three-dimensional screen-printed workpiece is the subject matter of claim 78. The use of a workpiece carrier is specified in claim 79 and a pharmaceutical product is specified in claim 80. Advantageous embodiments are the subject matter of the dependent claims and are explained below.

A workpiece carrier, in particular for the production of three-dimensional screen-printed workpieces, is equipped with at least one printing bed which has a printing surface to be printed on, and with a support structure which supports the printing bed and is formed separately from the printing bed. According to the invention, the support structure has a support base and at least one stop for the printing bed, wherein the printing bed is arranged on the support base, and wherein, in the position arranged on the support base, the printing bed can be brought to bear against the stop in at least one lateral direction.

According to the invention, the printing bed and the support structure are therefore components which are separate or independent of one another. In this way, the printing bed which has a printing surface to be printed on can be produced particularly with regard to the screen-printed workpieces to be produced in each case. In particular, the material selection of the printing bed can be undertaken with regard to the screen-printed workpieces to be produced in each case.

According to the invention, the printing bed can be produced primarily from a material which is particularly suitable for subsequent printing with the respective printing materials or printing pastes by way of three-dimensional screen printing. Consequently, the material selection of the printing bed can be undertaken taking into account the screen-printed workpieces to be produced in each case or the respective material of the screen-printed workpieces to be produced. At the same time, the printing bed can be realized with a relatively simple shaping, with the result that the effort in terms of production technology for the printing bed can be kept low.

By contrast, the support structure can be formed primarily with regard to the holding or supporting of the printing bed. There is the possibility of producing the support structure independently of the printing bed and thus particularly cost-effectively and at the same time robustly. In particular, the production of the support structure can be undertaken free of material requirements which can be predetermined by the screen-printed workpieces to be produced in each case. This results in an overall higher flexibility in the overall construction of the workpiece carrier. In the case of a robust design of the support structure, simplified handling possibilities for the entire workpiece carrier also result. A reduced risk of damage is the consequence.

As a result of the separate formation of the printing bed and of the support structure, a replacement of the respective printing bed can also be undertaken with relatively little effort, in particular with regard to changing production conditions. This results in an advantageous subsequent adaptability of the workpiece carrier. The flexibility of use can be further improved in this way.

In addition, in the case of a separate formation of the printing bed, cleaning of the latter can be brought about with only little effort without the entire workpiece carrier or, in addition, also the support structure of the workpiece carrier having to be subjected to cleaning.

Finally, as a result of the configuration according to the invention of the support structure with at least one stop for the printing bed, it is ensured that the printing bed can be arranged in a precisely predefined position on the support structure with only little effort. The precise positioning of the printing bed on the support structure is ensured by providing at least one stop with particularly little handling effort. This results in particularly high operational reliability in the use of the respective workpiece carrier.

In the present case, three-dimensional screen printing can be understood to mean, in a particularly preferred manner, an additive manufacturing method in which a powder-based suspension is transferred with the aid of a doctor blade through a solid printing mask onto a substrate and dried. This procedure can be repeated several times until the desired component height or component shape is reached in each case. In a final process step, the component produced in this way can be sintered. This can result in a screen-printed workpiece.

Likewise, in the present case, three-dimensional screen printing can be understood to mean, in a particularly preferred manner, an additive manufacturing method in which a powder-based suspension is transferred with the aid of a doctor blade through a solid printing mask onto a substrate and dried, the desired component height or component shape in each case being reached by a single print. In a final process step, a component produced in this way can be sintered and a screen-printed workpiece can be produced. Insofar as a plurality of printing processes are mentioned in the present case, instead of this one printing process can already be sufficient and suitable.

In the present case, a screen-printed workpiece can be understood to mean, in a preferred manner, a workpiece or a three-dimensional printed product which is to be subjected or has been subjected to a sintering step. This relates in particular to workpieces made of a metal, a ceramic, a glass material and/or a plastic material. In particular, alloys made of steel, nickel, copper, titanium and/or ceramic alloys come into consideration for this purpose.

Printed products made of plastic materials can be excluded or included by the designation “three-dimensional screen-printed workpiece”. In particular, there is also the possibility of subjecting printed workpiece layers made of plastic material to a sintering step.

In the present case, a screen-printed workpiece can likewise be understood to mean a workpiece or a three-dimensional printed product which has been produced free of a sintering step or can be produced or is produced free of a sintering step. Consequently, a final curing of printing layers can also be undertaken free of sintering steps. The curing of a screen-printed workpiece can advantageously also 30 be undertaken by UV curing and/or by a polymerization reaction and/or by drying, in particular by convection drying. Such a curing can preferably be undertaken in particular when a final curing of printing layers is intended to be undertaken free of sintering steps.

A screen-printed workpiece within the meaning of the present invention can furthermore be a pharmaceutical product and/or a biological product. Such screen-printed workpieces can be produced inter alia from pharmaceutical powder materials and/or powder mixtures and/or granules and/or from biological materials. In particular, pharmaceutical products and/or biological products can be produced free of sintering steps or can be sufficiently cured for the respective application.

Screen-printed workpieces produced from pharmaceutical powder materials and/or powder mixtures and/or granules can comprise medicaments, active substances, auxiliaries, in particular fillers and/or binders and/or disintegrants and/or lubricants.

According to the present teaching, a workpiece carrier, in particular the printing surface of the printing bed, can be provided and/or designed for direct printing. A workpiece carrier or the printing bed of such a workpiece carrier can therefore be provided as a direct printing base or for providing a printing surface to be printed on and/or be arranged or arrangeable within a device described below for producing three-dimensional screen-printed workpieces, in particular a 3D screen printing machine.

According to the present invention, a screen-printed workpiece can be a workpiece which is constructed on the workpiece carrier by three-dimensional screen printing in one or in a plurality of printing operations. In this case, the screen-printed workpiece is in particular a workpiece which, after completion of the printing operation and/or after completion of a sintering operation following the printing operation, can be released again from the workpiece carrier, in particular from the printing bed of the workpiece carrier, in particular can be released non-destructively.

Between possible printing operations for a screen-printed workpiece, the respective workpiece carrier can be released from the printing table or from the printing table plate of a device for producing three-dimensional screen-printed workpieces, in particular a 3D screen printing machine, or can be released therefrom. The individual layers of a screen-printed workpiece—in the case of a multilayer construction—can be dried between two successive printing operations in a position remote from the respective printing table or from the printing table plate of the device.

According to a preferred refinement of the present invention, the workpiece carrier can be designed and/or configured for production under clean-room conditions. In particular, the workpiece carrier and/or the device can be designed and/or configured for production under clean-room conditions according to the clean-room classes A, B, C and/or D according to EU-GMP.

Furthermore, a workpiece carrier according to the invention can be designed and/or configured for producing screen-printed workpieces for application in medical technology, in optical and/or laser technology, in aerospace technology, in semiconductor technology, in biotechnology and/or in medical and/or in pharmacological research.

Likewise, a workpiece carrier according to the invention can be designed and/or configured for producing screen-printed workpieces for use and/or application as medical and/or pharmaceutical products, implants and/or sterile products and/or medicaments and/or for use and/or application as tablets for active ingredient administration.

According to a preferred refinement of the workpiece carrier, the printing bed can be fastened to the support structure. In particular, in the position arranged on the support base and fastened to the support structure, the printing bed can bear in a lateral direction against the at least one stop of the support structure. By means of such an embodiment thereof, the risk of the printing bed becoming unintentionally detached from the support structure can be reduced. This results in an overall high positional reliability for the printing bed on the support structure.

A fastening of the printing bed to the support structure can advantageously be designed and/or provided to be maintained at least during a printing operation for a screen-printed workpiece and/or between possible printing operations for a screen-printed workpiece. Further preferably, a fastening of the printing bed to the support structure can advantageously be designed and/or provided to be maintained during all printing operations and/or between all printing operations for a screen-printed workpiece. In the course of the production of screen-printed workpieces within a 3D screen printing machine, the workpiece carrier can consequently be handled as a structural unit and correspondingly conveyed and/or positioned within the respective installation.

According to a further preferred embodiment, the support structure can have a plurality of stops for the printing bed. In the position arranged on the support base, the printing bed can be brought to bear in a plurality of lateral directions against a plurality of stops. In this way, a high positioning accuracy can be ensured in a plurality of lateral directions with only little handling effort.

According to the invention, a lateral direction can be understood to mean, in particular, a direction which extends parallel to a plane formed by the printing surface to be printed on. Along such a plane, the printing bed can be brought to bear in a particularly preferred manner in a plurality of lateral directions against a plurality of or different stops. The positioning of the printing bed along the plane formed by the printing surface can thus take place with particularly high accuracy and handling reliability.

According to a further preferred embodiment, a plurality of stops of the support structure can be formed by a single shaped body. This can be brought about with relatively little production effort. In addition, the embodiment can be implemented by a single shaped body with a particularly robust construction.

According to a further preferred embodiment, the stop can be designed as a side boundary for the printing bed. A plurality of stops can form a plurality of side boundaries for different sides of the printing bed. By means of a side boundary, the printing bed can be brought into contact with particularly high reliability or precise alignment and thus fixed in the lateral position.

It can be particularly advantageous if the at least one stop is designed for flat contact of the printing bed in a lateral direction, in particular on a contact surface of the stop. For this purpose, a correspondingly designed side surface or a correspondingly designed side surface section can advantageously be provided on the printing bed. An undesired tilting or the assumption of undesired rotated positions of the printing bed relative to the support structure can be avoided in this way with particularly high reliability. It is furthermore possible for a plurality of stops to be provided for flat contact of the printing bed in a lateral direction, as a result of which the positioning reliability can be further improved.

It is likewise possible for the stop to be designed for punctiform contact of the printing bed in a lateral direction. Such a stop can be provided with only little effort. It is furthermore possible for a plurality of stops to be provided for punctiform contact of the printing bed in a lateral direction. Consequently, in such an embodiment, the printing bed can be brought to bear in a punctiform manner in a lateral direction against a plurality of stops. A high positioning reliability and positioning accuracy for the printing bed can also be achieved by such an embodiment. The embodiment of the stop for punctiform contact of the printing bed is suitable, for example, even in the case of relatively large production tolerances of the printing bed. Independently of the production accuracy of the side surfaces of the printing bed, an unstable or tilting contact position of the printing bed against the stops can be prevented as a result.

According to a further preferred embodiment, a clearance section can be formed between a side surface section of the printing bed and the support structure. Along such a clearance section, the side surface section of the printing bed does not come into contact with a stop or any other contact surface of the support structure. Such a clearance section can extend, in particular, between two stops which are assigned to one side surface of the printing bed. A clearance section can be designed, in particular, as a gap between a side surface of the printing bed and the support structure. By means of such a clearance section, production tolerances of the printing bed and/or of the support structure can be compensated for in a suitable manner. An unstable or tilting contact position of the printing bed against the stops can also be suitably prevented in this manner.

According to a further preferred embodiment, the stop can extend relative to the support base along a thickness direction or height direction of the support structure and/or along a thickness direction or height direction of the printing bed. A thickness direction or height direction can be a direction which encloses an angle, in particular a right angle, with a lateral direction. In a position of the printing bed arranged on the support base, a stop for lateral contact of the printing bed can be created in this manner with only little constructional effort.

In a further preferred manner, the height of the stop relative to the support base in a thickness direction of the support structure and/or in a thickness direction of the printing bed can be dimensioned to be less than or equal to the thickness of the printing bed. It can thereby be avoided that the respective stop projects relative to the printing bed in the thickness direction or height direction. Impairments during printing in a printing device of a 3D screen printing machine, in particular collisions between a printing screen or doctor blade and the respective stop of the workpiece carrier, can thereby be avoided.

Particularly preferably, the printing surface of the printing bed can be aligned flush with an upper side of the at least one stop. Further preferably, the printing surface of the printing bed can be aligned flush with surface sections of the upper side of the support structure.

Here, a flush alignment can be understood to mean that the printing bed terminates at the same height or substantially at the same height as the upper side of the at least one stop or terminates at the same height or substantially at the same height as surface sections of the upper side of the support structure.

For the workpiece carrier, an overall planar or substantially planar surface or a surface free or substantially free of projections in the thickness direction or height direction can thus be created. By means of such a flush alignment without projections or substantially without projections on the upper side of the workpiece carrier, impairments during printing in a printing device of a 3D screen printing machine can be particularly reliably avoided.

Consequently, in the present case, a flush alignment can also be understood to mean only a substantially flush alignment, in particular an alignment substantially without projections and/or with a substantially planar surface of the workpiece carrier. A substantially flush alignment can already be present if impairments during printing in a printing device of a 3D screen printing machine, in particular impairments of a doctor blade movement by the upper side of the workpiece carrier, can be avoided.

According to a further preferred embodiment, the stop can be formed as a shaped body and/or shaped body section which extends relative to the support base along a thickness direction of the support structure and/or along a thickness direction of the printing bed. The stop can be formed by a pin section and/or block section on an upper side of the support structure. Such a pin section or block section on an upper side of the support structure can be applied and/or fastened subsequently, for example. A shaped body or shaped body section can be formed integrally with the support base of the support structure, for example, as a result of which a particularly robust embodiment results for the support structure.

According to a further preferred embodiment, the support structure can have an insertion cavity for the printing bed. In this case, the printing bed can be at least partially embedded in the insertion cavity. The positioning of the printing bed in such an insertion cavity can be brought about with only little handling effort, in particular with a low risk of manual operating errors. At the same time, an insertion cavity ensures a high degree of positional reliability for the printing bed relative to the support structure.

It can further be advantageous if the printing bed is completely embedded in an insertion cavity. Likewise, according to a preferred embodiment, the printing surface of the printing bed can be aligned flush with surface sections of the upper side of the support structure which surround the insertion cavity. In this manner, sections projecting relative to the printing bed in the thickness direction or height direction can be avoided. Impairments of the printing process or geometric collisions with the respective printing screen and/or doctor blade of a printing device can thereby be avoided.

According to a further preferred embodiment, the insertion cavity can be delimited at least in sections by the support base and/or by one or more side walls and/or by the at least one stop or a plurality of stops. Such an insertion cavity can therefore define or delimit the position of the printing bed in a plurality of dimensions with a simple constructional design.

According to a further preferred embodiment, the stop can be formed by or on a side wall of the insertion cavity. In particular, the stop can be formed by a side wall section of the insertion cavity and/or by a side projection of a side wall of the insertion cavity. A side projection of a side wall can project laterally in the direction of the printing bed with respect to adjacent side wall sections of the insertion cavity and thus form a stop or a contact surface for the printing bed.

A clearance section can be formed between the printing bed and at least one side wall of the insertion cavity. In this case, a clearance section can extend between two side projections of a side wall of the insertion cavity.

Furthermore, in each case one stop can be formed by, in each case, one side wall of the insertion cavity or a plurality of stops can be formed by the same side wall of the insertion cavity. Adjacent and/or opposite side walls of the insertion cavity can therefore form different stops. In this manner, a printing bed can be brought to bear, for example, against two side walls of an insertion cavity or against side projections of different side walls of the insertion cavity and is thus fixed in position along a plurality of directions in a position arranged on the support base. The risk of incorrect positioning of the printing bed relative to the support structure can thereby be avoided or reduced to a low degree.

Further preferably, the support structure can have precisely three stops for lateral contact of the printing bed. In particular, the support structure can have precisely three stops formed as side projections of one or more side walls of the insertion cavity. In this case, preferably two side projections can be formed on the same side wall of the insertion cavity and a further side projection can be formed on a neighboring or adjacent side wall of the insertion cavity. This enables stable contact of the printing bed at three defined points or three side surface sections of the printing bed and thus secure positioning relative to the support structure.

According to a further preferred embodiment, the support structure can have a frame section which is connected to the support base. In this case, the frame section can preferably have a greater thickness than the support base. The stop can be formed and/or arranged on the frame section. This results in a particularly simple and robust constructional embodiment of the support structure. In addition, by means of such a frame section, a particularly suitable enclosure in lateral directions for the printing bed can be provided.

According to a further preferred embodiment, the insertion cavity can be delimited at least in sections by the frame section and the support base. In this case, the side walls of the insertion cavity or also the stops or the stops formed as side projections of the side walls can be formed on the frame section. A frame section therefore ensures a high degree of stability for the support structure and, at the same time, the side walls of the insertion cavity can be formed on the frame section with only little production effort. The frame section and/or the side walls can surround the insertion cavity preferably circumferentially, in particular completely circumferentially, and/or laterally all around.

According to a further preferred embodiment, the frame section and the support base can be designed to be connected to one another in one piece. It is likewise possible for the support base to be formed separately from the frame section and to be fastened to the latter, wherein the support base can preferably be fastened to the frame section in a floating manner. Such a floating mounting can be provided in particular in order to compensate for temperature-induced expansion behavior of the support base relative to the frame section. By contrast, a one-piece design of the frame section and of the support base can contribute to a particularly stable overall construction.

According to a further preferred embodiment, the printing bed can be formed at least in sections from a material which differs from a material of the support structure. Additionally or alternatively, the printing bed can be formed at least in sections from a material having a constitution and/or composition which differs from the constitution and/or composition of a material of the support structure.

Consequently, both the printing bed and the support structure can be specifically designed or constituted on the material side or on the substance side with regard to the function to be fulfilled in each case as part of the workpiece carrier.

The material or the constitution and/or the composition of the material of the printing bed can be selected for providing a printing surface optimized for the respective printing process. By contrast, the material or the constitution and/or the composition of the material of the support structure can be selected for achieving high stability requirements and cost-effective production. Subdivision of the workpiece carrier into support structure and printing bed therefore makes it possible to contribute to functional subdivision and thus to a high degree of functional efficiency by different material selection for the printing bed and the support structure.

According to a further preferred embodiment, the support structure can be formed at least in sections from a metal material, in particular from a light metal material. In a particularly preferred manner, the support structure can be formed at least in sections from an aluminium material and/or from a titanium material and/or from a steel material. Such metal materials have a high degree of strength and can be processed with relatively little effort, with the result that the production of a correspondingly produced support structure is made possible with little cost effort. A light metal material, for example an aluminium material, also ensures only a low weight of the support structure, as a result of which handling during production is simplified.

It can further be advantageous if the support base is formed at least in sections from a steel sheet. Furthermore, it is possible for the support base to be formed at least in sections from a light metal material, in particular from an aluminium material and/or from a titanium material. With a relatively low weight, such a support base has a sufficiently high degree of strength and therefore ensures reliable reception of the printing bed during the production of three-dimensional screen-printed workpieces.

According to a further preferred embodiment of the workpiece carrier, the support base can be formed at least in sections from a material which differs from a material of at least one further portion of the support structure, in particular from a material of the frame portion of the support structure. The desired material properties can thus be specifically set in each case for the different portions or parts of the support structure.

For example, the support base can be produced from a material of higher strength, with the result that a sufficiently high stability can be ensured even with a low thickness of the support base. By contrast, a frame section of greater thickness can be produced, for example, from a light metal material, with the result that an overall relatively low weight of the support structure can be ensured with simultaneously high stability requirements.

According to a further preferred embodiment, at least one portion of the support base and at least one further portion of the support structure, in particular the frame portion of the support structure, can be formed from an identical material. The support base and the frame section can preferably be formed completely from an identical material. The selection of identical materials for different portions of the support structure can contribute to simplified production or also to an overall simplified constructional design.

The printing bed can be formed at least in sections from a titanium material and/or from a glass material and/or from a steel material, in particular a steel sheet, and/or from a magnetic steel, and/or from an aluminium material. Additionally or alternatively, the printing bed can be formed from a ceramic material and/or from a sintered material. By means of a titanium material or glass material or also by means of a ceramic material, the risk of reactions with the material of a screen-printed workpiece to be produced can be reduced to a low degree. The use of a steel material for the printing bed can ensure a high longevity of the printing bed. In addition, in the case of a magnetic steel material, magnetic fixing of the printing bed on the support structure can be brought about with only simple means.

According to a further preferred embodiment, the support structure and the printing bed together can have a total weight of less than 10 kg, preferably of less than 8 kg, further preferably of less than 7 kg, further preferably of less than 6 kg, further preferably of less than 5 kg, further preferably of less than 4.5 kg, further preferably of less than 4 kg, further preferably of less than 3.5 kg, further preferably of less than 3 kg, further preferably of less than 2 kg or 2 kg. The support structure and the printing bed in a common arrangement can be handled with only little effort in the case of such a limitation of the weight. In particular, in the case of such a weight limitation, in addition to the automated handling, manual handling by the respective operating personnel also comes into consideration, with the result that a high degree of flexibility results for use during the production of three-dimensional screen-printed workpieces.

In a still further preferred embodiment, the support structure and/or a frame section of the support structure and/or the common arrangement of the printing bed and of the support base can have a maximum thickness of less than 10 mm, preferably of less than 8 mm, further preferably of less than 7 mm, further preferably of less than 6 mm, further preferably of less than 5 mm, further preferably of less than 4 mm or approximately 4 mm. Likewise, the support structure and/or a frame section of the support structure and/or the common arrangement of the printing bed and of the support base can have a maximum thickness of less than 3 mm or approximately 3 mm, further preferably of less than 2 mm or approximately 2 mm. In the case of such a maximum thickness, the workpiece carrier can be gripped particularly well both in the course of manual handling and by automated handling. Likewise, with such a maximum thickness, it can be avoided that a workpiece carrier piles too much on a printing table or within the respective printing device of a 3D screen printing machine. Specific adaptation of the printing kinematics as a function of the respective workpiece carrier can thereby be avoided or reduced to a low degree.

According to a further preferred embodiment, the support structure and/or a frame section of the support structure and/or the common arrangement of the printing bed and of the support base can have a thickness of more than 0.5 mm, preferably of more than 1 mm, further preferably of more than 1.5 mm, further preferably of more than 2 mm, further preferably of more than 2.5 mm, further preferably of more than 3 mm, further preferably of more than 3.5 mm, further preferably of more than 4 mm, further preferably of more than 4.5 mm, still further preferably of more than 5 mm. This promotes sufficient stability of the workpiece carrier or sufficient overall stability of the workpiece carrier. At the same time, good and reliable handling of the workpiece carrier can be ensured in the case of such thickness dimensioning.

According to a further preferred embodiment, the support structure and/or a frame section of the support structure and/or the common arrangement of the printing bed and of the support base can have a thickness of 0.5 mm to 10 mm, in particular a thickness of 0.8 mm to 8 mm, further preferably of 1 mm to 6 mm, still further preferably a thickness of 1 mm to 5 mm, still further preferably a thickness of 1 mm to 4 mm, still further preferably a thickness of 1 mm to 3 mm, still further preferably a thickness of 1.5 mm to 2.5 mm, in particular of approximately 2 mm. In the case of such a thickness, on the one hand a sufficiently robust overall construction can be ensured. At the same time, good handleability of the workpiece carrier and also a suitable fixing within a printing device or within a conveying vehicle of a 3D screen printing machine can thereby be undertaken. The respectively desired positioning of the workpiece carrier within a 3D screen printing machine can be undertaken with relatively little effort in the case of such dimensions.

According to a further preferred embodiment, the printing bed can have a thickness of more than 0.5 mm, preferably of more than 1 mm, further preferably of more than 1.5 mm, further preferably of more than 2 mm, further preferably of more than 2.5 mm, further preferably of more than 3 mm, further preferably of more than 3.5 mm, further preferably of more than 4 mm, further preferably of more than 4.5 mm, still further preferably of more than 5 mm. In the case of such a minimum thickness, a high degree of dimensional stability of the printing bed can advantageously be ensured. Undesired deformations, which could result, for example, in an uneven printing surface, can be avoided in the case of a sufficiently large thickness of the printing bed. In addition, in the case of such a minimum thickness, damage-free removal or removal of the printing bed from the support structure is facilitated. This likewise applies to the process of positioning the printing bed on the support structure or to the fixing of the printing bed on the support structure or within the respective insertion cavity.

According to a further preferred embodiment, the printing bed can have a thickness of less than 10 mm, preferably of less than 8 mm, further preferably of less than 7 mm, further preferably of less than 6 mm, further preferably of less than 5 mm, further preferably of less than 4 mm or approximately 4 mm, further preferably of less than 3 mm or approximately 3 mm, still further preferably of less than 2 mm or approximately 2 mm. The weight of the printing bed can be suitably limited in the case of such a thickness, with the result that good handling properties result. At the same time, in the case of such a thickness, the height of the stop relative to the support base of the support structure can also be limited, with the result that an overall relatively low thickness of the workpiece carrier can be achieved. An above-mentioned maximum thickness of the printing bed contributes overall to a limited thickness of the workpiece carrier or of the common arrangement of support structure and printing bed.

According to a further preferred embodiment, the support structure and/or the insertion cavity and/or the support base and/or the frame section of the support structure and/or the printing bed can have a rectangular, in particular square, shape in a plan view. The printing bed can be designed, in particular, as a printing bed plate. In the case of such a shaping, on the one hand a particularly advantageous fixing within a conveying vehicle of a 3D screen printing machine can be undertaken. At the same time, in the case of a rectangular, in particular square, shape with regard to the respective geometric embodiments of the printing screen or of the printing table to be used in each case for printing, a high degree of surface utilization on the printing bed can be ensured.

Conventional printing screens or printing table plates likewise have a rectangular, in particular square, shape. A corresponding shaping of the printing bed and/or of the support base, of the insertion cavity or also of the support structure overall can contribute to good surface utilization of the printing bed or of the printing surface formed by the printing bed during operation.

According to a further preferred embodiment, the support structure can have a side edge length or a plurality of side edge lengths of at least 50 mm, preferably of at least 100 mm, preferably of at least 150 mm, preferably of at least 200 mm, preferably of at least 250 mm, preferably of at least 300 mm, preferably of at least 350 mm, preferably of at least 400 mm, preferably of at least 450 mm, further preferably of at least 475 mm. By means of a support structure dimensioned in this way, a relatively large printing bed can be positioned thereon, with the result that a relatively large printing surface can also result.

Even further preferably, the support structure can have a side edge length or a plurality of side edge lengths of up to 1000 mm, preferably of up to 900 mm, preferably of up to 800 mm, preferably of up to 700 mm, preferably of up to 600 mm, preferably of up to 550 mm, further preferably of up to 525 mm, even further preferably of up to 500 mm, even further preferably of up to 450 mm, even further preferably of up to 400 mm, even further preferably of up to 300 mm. A support structure dimensioned in this way enables an overall compact and stable construction and also good handleability of the respective workpiece carrier during positioning in or on a printing device or a printing table of a 3D screen printing machine or also on a conveying vehicle of a 3D screen printing machine. This likewise applies to the removal of a workpiece carrier with a support structure dimensioned in this way from a respective arrangement or position within a 3D screen printing machine.

In a still further preferred manner, the printing bed can have a side edge length or a plurality of side edge lengths of at least 25 mm, of at least 50 mm, preferably of at least 100 mm, preferably of at least 150 mm, preferably of at least 200 mm, preferably of at least 150 mm, preferably of at least 300 mm, further preferably of at least 350 mm, even further preferably of at least 400 mm, even further preferably of at least 450 mm, even further preferably of at least 500 mm. In the case of such dimensioning of the printing bed, a sufficiently large printing surface for printing with three-dimensional screen-printed workpieces can be provided.

Further preferably, the printing bed can have a side edge length or a plurality of side edge lengths of up to 900 mm, preferably of up to 800 mm, preferably of up to 700 mm, preferably of up to 600 mm, even further preferably of up to 500 mm, even further preferably of up to 400 mm, even further preferably of up to 300 mm, even further preferably of up to 200 mm, even further preferably of up to 100 mm, even further preferably of up to 75 mm, even further preferably of up to 50 mm. Such a printing bed can on the one hand provide a sufficiently large printing surface for printing with three-dimensional screen-printed workpieces. At the same time, good handleability of the printing bed can be ensured in the case of such a limitation of the dimensioning. In addition, in the case of such a dimensioning, a limitation of the side edge length of the support structure which carries the printing bed can also occur, with the result that an overall robust and compact construction of the entire workpiece carrier results.

It can further be advantageous if the support structure is designed as a milled component and/or is produced at least in sections by milling production. As a result, the support structure can be given a relatively complex shaping, with simultaneously little effort in terms of production technology. In addition, sufficient stability of the support structure can be ensured by milling production or by formation as a milled component.

In a further preferred manner, the printing bed can be released non-destructively and/or tool-free from the support structure. The printing bed can furthermore be removable or removable non-destructively and/or tool-free, in particular exclusively by manual handling and/or actuation, from the insertion cavity of the support structure. As a result, a simple replacement of the printing bed or the removal of the printing bed for the purpose of carrying out cleaning can be undertaken. In the case of damage, the printing bed can be simply replaced in this manner and replaced by a new printing bed. Likewise, as a result of such a configuration, different printing beds for different conditions of use can be arranged on the support structure or inserted in the insertion cavity with only little effort. There is therefore the possibility of using a support structure alternately with different printing beds, as a result of which an overall material-saving or resource-saving mode of operation can be achieved. In the case of such a configuration, it is not necessary to also provide a dedicated support structure for each printing bed, with the result that savings can be undertaken in any case on the number of support structures in operational use.

According to a still further preferred embodiment, the support structure can have a grip recess via which a side surface of the printing bed can be manually contacted in an arrangement positioned in the insertion cavity. In particular, the grip recess can be dimensioned such that an operator can carry out a lateral contacting of the printing bed at least by means of a finger in an arrangement of the printing bed positioned in the insertion cavity. Such a grip recess therefore simplifies the manual handling of the printing bed, in particular for inserting or removing the printing bed into or from the insertion cavity. A grip recess can advantageously be designed as an indentation in a side wall of the insertion cavity.

According to a still further preferred embodiment, the printing bed can be fastened to the support structure and/or within the insertion cavity in a floating manner, in particular in order to compensate for temperature-induced expansion behavior relative to the support structure. In particular in the case of the use of different materials for the printing bed and the support structure, undesired stress states or jamming of the printing bed on the support structure or within the insertion cavity can be avoided. By means of a floating mounting, a suitable compensation can take place. A floating mounting of the printing bed on the support structure and/or within the insertion cavity can enable mobility or expansion of the printing bed relative to the support structure in at least one lateral direction or else in a plurality of lateral directions.

It is likewise possible for the printing bed to be fastened to the support structure and/or within the insertion cavity in a play-free or substantially play-free manner. A play-free or substantially play-free mounting of the printing bed on the support structure and/or within the insertion cavity can prevent movement of the printing bed relative to the support structure in at least one lateral direction or in a plurality of lateral directions or reduce the mobility to a low degree. The position of the printing bed relative to the support structure can be fixedly predetermined in this manner in the respective direction or orientation. The risk of undesired incorrect positioning of the printing bed relative to the support structure can thereby be reduced.

According to a still further preferred embodiment, the printing bed can be fastened in a force-fitting and/or form-fitting and/or material-bonded manner to the support structure and/or within the insertion cavity. Such a fastening can be undertaken in a particularly advantageous manner in a position bearing in a lateral direction against at least one stop or against a plurality of stops. By means of a force-fitting and/or form-fitting and/or material-bonded fastening, an overall high degree of fastening reliability for the printing bed on the support structure and/or within the insertion cavity can be ensured. The risk of an undesired detachment of the printing bed from the support structure can thereby be reduced.

The printing bed can be magnetically fastened in a particularly advantageous manner to the support structure and/or within the insertion cavity. The printing bed can be fastened to the support structure and/or within the insertion cavity by at least one magnetic film and/or by at least one neodymium magnet. By means of magnetic fixing, on the one hand a high degree of fastening reliability can be achieved. At the same time, magnetic fastening can ensure simple and at the same time non-destructive removal of the printing bed from the support structure or from the insertion cavity.

Further preferably, at least one magnet, in particular a magnetic film and/or a neodymium magnet, can be fastened to the printing bed. Preferably, such a magnet can be adhesively bonded to an underside of the printing bed that faces the support base and/or embedded within the printing bed. This can be brought about with relatively little effort and makes possible the magnetic fastening of the printing bed also to other suitable support structures which, for their part, either have a magnetic material or at least one corresponding magnet.

Additionally or alternatively, at least one magnet, in particular a magnetic film and/or a neodymium magnet, can be fastened to the support base of the support structure and/or embedded and/or adhesively bonded in the support base. By means of such a configuration, a printing bed which consists at least partially of a magnetic material or is equipped for its part with at least one magnet can be fixed to the support structure simply and with high reliability. The positioning of a magnet on the support base and/or embedded in the support base and/or adhesively bonded in the support base is particularly space-saving and ensures a high degree of fastening reliability.

Additionally or alternatively, the printing bed can be adhesively bonded to the support structure and/or within the insertion cavity, preferably by an adhesive tape or by a plurality of adhesive tape sections. Such a configuration is simple to construct and cost-effective to provide. In addition, a high degree of fastening reliability and at the same time simple replaceability of the printing bed or removal of the printing bed from the respective support structure or from the insertion cavity can also be ensured by means of such an adhesive bond.

In a particularly preferred manner, the adhesive tape can be adhesively bonded between the printing bed and the support base. Additionally or alternatively, the printing bed can be adhesively bonded to the support structure by adhesive tape which is adhesively bonded to the printing bed and the support structure in an overlapping manner on an upper side of the printing bed that faces away from the support base. Such a type of fastening can be brought about with only little manual effort and is particularly cost-effective.

According to a further preferred embodiment, the printing bed can be fixedly clamped to the support structure and/or within the insertion cavity by at least one spring device. In particular, the printing bed can be clamped and/or tensioned by at least one spring device against at least one side wall or a side wall section of the insertion cavity and/or against a side projection of a side wall of the insertion cavity. By such a clamping or clamping of the printing bed, the position thereof within the support structure or on the support structure can be particularly well maintained or permanently maintained. In this case, the printing bed can generally be clamped and/or tensioned against at least one stop by a spring device. The position of the printing bed in a position bearing against the stop can therefore be maintained particularly reliably by the spring device.

In a further preferred manner, the printing bed can be fixedly clamped to the support structure and/or within the insertion cavity by a plurality of spring devices. In particular, the printing bed can be clamped and/or tensioned laterally against a plurality of stops or a plurality of side walls of the insertion cavity and/or against a side projection or against a plurality of side projections of a side wall or against a plurality of side walls of the insertion cavity by a plurality of spring devices. The spring devices can therefore contribute to a particularly high positional accuracy of the printing bed relative to the support structure.

The at least one spring device can preferably act laterally on the printing bed, in particular on at least one side surface of the printing bed which extends between the upper side of the printing bed that faces away from the support base and the underside of the printing bed that faces the support base. A force effect in the lateral direction on the printing bed can thus be achieved.

Furthermore, a plurality of spring devices can act laterally on the printing bed, in particular on a plurality of mutually adjacent side surfaces of the printing bed which extend between the upper side of the printing bed that faces away from the support base and the underside of the printing bed that faces the support base. As a result, lateral force effects in different lateral directions on the printing bed can be realized by the spring devices. The bearing of the printing bed against the respective stop of the support structure can thereby be easily achieved and maintained during operation.

In a still further preferred manner, in a plan view of the printing bed, a tensioning force of the spring device can act diagonally on the printing bed and/or extend diagonally through the printing bed. It is likewise possible that, in a plan view of the printing bed, a tensioning force of the spring device acts generally obliquely on the printing bed and/or extends obliquely through the printing bed, in particular at an angle of more than 90° or less than 90° relative to a side edge or side surface of the printing bed. In this manner, lateral contact of the printing bed against two stops or against two side walls or two or more side wall sections or side projections of one or more side walls of the insertion cavity can be brought about by a single spring device. The risk of operating errors can thereby be reduced to a low degree.

In a still further preferred manner, the at least one spring device can act laterally on a corner region and/or a corner surface of the printing bed. A corner region can be a region adjacent to a corner. Accordingly, a corner surface can be a surface adjacent to a corner. A spring force extending diagonally through the printing bed or acting obliquely on the printing bed in a plan view of the printing bed can be applied in a particularly reliable manner by such an embodiment.

In a still further preferred manner, the at least one spring device can have a cutout for the contact-free and/or load-free reception of a corner and/or edge, in particular of a corner edge or edge of a corner region, of the printing bed. Here, a corner edge or edge of a corner region is to be understood to mean an edge by which two side surfaces which extend between an upper side of the printing bed and an underside of the printing bed are delimited with respect to one another. A corner edge or edge of a corner region therefore connects two neighboring corners, namely a corner on an upper side to a corner on an underside of the printing bed. Stress peaks both in the material of the printing bed and at the contact surfaces of the spring device can be avoided by a cutout for the contact-free and/or load-free reception of a corner and/or edge of the printing bed, with the result that undesired material stresses can be completely prevented or reduced to a low degree.

In a further preferred manner, the printing bed can have at least one flattened or rounded corner region or at least one flattened or rounded corner edge, in particular a plurality of flattened or rounded corner regions or a plurality of flattened or rounded corner edges. Therefore, at least one edge of a corner region and/or of a corner edge of the printing bed can be of flattened or rounded design. By means of such a flattened or rounded configuration of a corner region or of an edge of a corner region and/or of a corner edge, high surface pressures and associated material impairments in corner regions or edge regions of the printing bed can be avoided. The risk of damage to the printing bed in the course of handling or positioning and/or clamping on the support structure can thereby be reduced.

In a further preferred manner, the spring device can be designed for receiving a flattened and/or rounded corner region and/or a flattened and/or rounded corner edge of the printing bed. In particular, the spring device can have a contact surface shaped correspondingly to the flattened and/or rounded corner region and/or to a flattened and/or rounded corner edge. The contacting of the printing bed by means of such a spring device for the purpose of restraining or for the purpose of clamping the printing bed is, with such an embodiment, associated with only a low risk of high surface pressures. There is therefore only a low risk of damage to the printing bed and/or to the spring device.

According to a still further preferred embodiment of the workpiece carrier, the support structure can be designed for the arrangement or reception of a plurality of printing beds. Preferably, a plurality of printing beds formed separately from one another can generally be arranged and/or fastened on the support structure, in particular in each case on a support base or on a common support base. In a further preferred manner, the support structure can have in each case at least one stop for a plurality of printing beds, against which stop the respective printing bed can be brought to bear in at least one lateral direction in a position arranged on the respective support base.

By means of such an embodiment, the flexibility of use of the respective workpiece carrier can be further improved overall. Instead of a relatively large printing bed, a plurality of relatively small printing beds can be provided, which can be exchangeable independently of one another or can be fastened on the support structure. In the case of damage, it can be sufficient, for example, to replace only one printing bed. The handling of a plurality of small printing beds can likewise be brought about particularly simply, in particular with a reduced risk of damage.

In a still further preferred embodiment, the support structure can have a plurality of insertion cavities for a plurality of printing beds, wherein a printing bed is preferably at least partially embedded and/or fastened in each insertion cavity. Each printing bed can be brought to bear within the insertion cavity against at least one stop, in particular against at least one side wall or against a side wall section and/or side projection of a side wall of the insertion cavity in a lateral direction. This permits secure and precise positioning of a plurality of printing beds relative to the support structure.

In a still further preferred manner, each printing bed can be fixedly clamped to the support structure and/or within the respective insertion cavity by at least one spring device, in particular can be clamped and/or tensioned laterally against a plurality of side walls or against a plurality of side wall sections and/or against a plurality of side projections of a side wall or a plurality of side walls of the respective insertion cavity. Consequently, each printing bed can be brought to bear in at least one lateral direction against a stop designed as a side wall of the respective insertion cavity. In this way, a high fastening reliability and positioning accuracy results for a plurality of printing beds.

According to a further preferred embodiment, the spring device can be tensioned and/or released in a tool-based manner. If a plurality of spring devices are provided, a plurality of spring devices can also be tensioned and/or released in a tool-based manner. The clamping can take place in a tool-based manner with high reliability and relatively high tensioning forces. By contrast, an undesired release or an inadvertent release is unlikely.

The at least one spring device and/or the plurality of spring devices can alternatively also be tensioned and/or released in a tool-free manner. As a result, the tensioning and/or releasing can be brought about with only little handling effort and by the operating personnel without the aid of further operating means.

According to a still further preferred embodiment, the printing bed can be held down and/or fixedly clamped to the support structure and/or within the insertion cavity by at least one hold-down device. In this case, the hold-down device can preferably be fixedly screwed to the support structure. Additionally or alternatively, the hold-down device can engage in a shaped portion of the printing bed shaped correspondingly to the hold-down device. As a result, a particularly high degree of fastening reliability for the printing bed on the support structure and/or within the insertion cavity can be ensured.

At the same time, the engagement of the hold-down device in a shaped portion of the printing bed can ensure a relatively planar upper side of the workpiece carrier. It can thereby therefore be avoided that the hold-down device projects relative to the printing bed in the thickness direction or height direction. Likewise, the hold-down device can engage in a correspondingly shaped portion of the support structure or be embedded in such a shaped portion. A projecting of the hold-down device relative to the upper side of the support structure on the portions surrounding the printing bed can thus also be avoided.

The hold-down device can preferably be designed as a hold-down disc. Such a hold-down disc can be provided cost-effectively and ensures a high degree of functional reliability.

The hold-down device can furthermore preferably form a floating bearing. In such an embodiment, the hold-down device can therefore exclusively provide a hold-down function and at the same time enable a lateral movement of the printing bed relative to the hold-down device and/or relative to the support structure, for example in order to compensate for temperature-induced expansion.

In addition to a hold-down device designed as a floating bearing, the printing bed can also be fastened to the support structure by a fixed mounting. Such a fixed mounting can be produced, for example, by a screw connection, in particular by a plurality of screw connections. For this purpose, at least one screw can project through an opening of the printing bed and be screwed into the support base of the support structure. A plurality of screw connections can likewise be provided. Lateral movements of the printing bed relative to the support structure can therefore also be blocked in the region of such a fixed mounting.

In general, a fastening of the printing bed to the support structure and/or in the insertion cavity can be realized by a fixed-floating bearing arrangement. This can be a fixed-floating bearing arrangement in lateral directions of the printing bed relative to the support structure.

The hold-down device can still furthermore preferably be designed as an engagement groove for the printing bed. Such an engagement groove can be introduced, for example, in a side wall of the insertion cavity. The printing bed can have a shaping corresponding to the engagement groove, in particular the printing bed can have an engagement section which can be introduced into the engagement groove. Such an engagement section can be designed to be thinner than the remaining sections of the printing bed. In this way, a planar overall surface of the workpiece carrier can be ensured, in particular without projections on the upper side of the workpiece carrier.

Still furthermore preferably, the support base can have at least one through-bore suction opening, in particular a plurality of suction openings, for applying a negative pressure to the printing bed and/or for suctioning the underside of the printing bed for temporary fixing within a printing device of a 3D screen printing machine. Therefore, a negative pressure can be generated via such suction openings on the underside of the printing bed or on the side of the printing bed that faces the support structure, by means of which negative pressure the printing bed is fixed in the respective position.

Such a fixing by means of negative pressure can be undertaken not only relative to the support structure but also relative to the respective printing device of the 3D screen printing machine. In a position fixed in this way, material can be applied or printed on the printing bed in a particularly advantageous manner by means of three-dimensional screen printing, in particular without the risk that the printing bed slips as a result of a printing operation or assumes an undesired or inaccurate position.

According to a further preferred configuration, the printing bed and/or the position and/or alignment or generally the position of the printing bed can be optically detectable starting from a side of the support structure facing away from the printing bed. As a result, an upper-side position detection of the printing bed can be dispensed with and a conclusion can also be drawn from an underside of the support structure as to the position and/or alignment or the position of the printing bed in general. This permits a more flexible use of the workpiece carrier, in particular also in 3D screen printing machines which have no upper-side position detection for the workpiece carrier or for the printing bed of a workpiece carrier.

By means of a lower-side position detection of the printing bed, starting from a side of the support structure facing away from the printing bed, a precise printing of a plurality of layers on one another can nevertheless be achieved in order finally to produce the respective three-dimensional screen-printed workpiece. In the case of a simplified construction of a 3D screen printing machine or a printing device with only lower-side position detection of a printing bed, an overall high degree of production accuracy can be achieved.

The individual layers of a screen-printed workpiece can be printed on one another with high precision by such a position detection of the printing bed. This applies in particular to the multiple and successive arrangement of the workpiece carrier within a printing device for carrying out successive printing steps.

According to a further preferred embodiment, the support structure can have at least one viewing region. The position and/or alignment of the printing bed can be optically detectable at least through the viewing region of the support structure. Such a viewing region can be easily provided and enables secure optical detection of the printing bed and accordingly also precise position and alignment setting.

A viewing region can be formed in a particularly advantageous manner by a viewing opening. Such a viewing opening can be provided in the support structure only with little effort. A viewing opening can be formed in particular by a material cutout.

Further preferably, the viewing region can be formed at least in sections from a transparent and/or translucent material. For example, the support structure can have a cutout in which a transparent and/or translucent material is inserted. Secure optical detection can be effected by a transparent and/or translucent material. At the same time, such a viewing region made from a transparent and/or translucent material enables the respective printing bed to lie over the full area.

A transparent material is a material which is almost completely penetrated by incident electromagnetic radiation of a more or less broad frequency spectrum, that is to say is hardly reflected and hardly absorbed. In particular, a transparent material can be transparent or clear if it is possible to clearly identify the material lying behind it, that is to say the material is transmissive or largely transmissive to radiation of the visible spectrum, in particular without or almost without light scattering.

Here, a translucent material is to be understood to mean a material which is partially or partly transmissive to light. Translucent materials can therefore reflect incident light not only directly at their surface, but partly only after it has penetrated into the material. Consequently, subsurface scattering can result by translucent materials.

In a further preferred manner, the support structure adjacent to the viewing region can be formed at least in sections by a material which is impermeable to light. In the case of optical detection, a simple differentiation of the at least one viewing region from an adjacent region which is therefore not relevant for the optical detection of the printing bed can be undertaken in this manner.

In a still further preferred embodiment, the support structure can have a plurality of viewing regions formed independently of one another. In this case, the support structure can further preferably be formed, between different viewing regions, at least in sections from a material which is impermeable to light. The detection reliability and detection accuracy can be further improved in this way.

At least one corner and/or edge and/or a contour portion of the printing bed can be optically detectable through a viewing region of the support structure. A corner and/or edge and/or a contour portion can be detected relatively well by a viewing region. By means of such a configuration, the position and/or alignment of the printing bed or the position thereof can generally be detected with high reliability and accordingly an alignment either of the printing bed or of the workpiece carrier together with the printing bed and/or of the printing screen to be used in each case can be undertaken.

Further preferably, the at least one viewing region of the support structure can be partially covered in plan view by a corner region and/or edge region and/or contour portion of the printing bed. By means of a partial covering, the respective section of the printing bed can be detected with high reliability. The partial covering creates a contrast to sections of the viewing region which are not covered for the optical detection.

Further preferably, at least one viewing region of the support structure or a viewing opening of the support structure can be formed at least in sections in the frame section and/or at least in sections in the support base of the support structure. In this way, a partial covering of the viewing opening or of the viewing region can be detected optically particularly well.

According to a still further preferred embodiment, the support base can be formed separately from the frame section and the printing bed can cover the support base in plan view and/or cover the support base in a projecting manner. A separate formation of the support base and of the frame section results in greater production flexibility for the workpiece carrier. At the same time, a covering arrangement of the printing bed on the support base can result in good optical discernibility for the printing bed from the side of the support structure facing away from the printing bed.

Still further preferably, the support structure and/or the frame section and/or the printing bed of the workpiece carrier can be provided with at least one marking for position detection, in particular a plurality of markings for position detection. The position and/or alignment of the support structure and/or of the printing bed of the workpiece carrier can be detectable via such a marking. The production reliability in layerwise construction by way of three-dimensional screen printing can be improved by the optical detection of a marking. The risk of incorrect positioning of the printing bed in a subsequent printing operation can thereby be further reduced.

A marking in question here can be formed as an optically detectable marking and/or reference bore and/or register mark. Such a marking can be optically detected with only little apparatus effort and high reliability.

Furthermore, the at least one marking can preferably be formed separately from the corners and/or edges of the support structure and/or of the printing bed. Detection via such a marking can be undertaken additionally or alternatively to the optical detection of a corner region and/or edge region and/or contour portion of the printing bed. The possibilities of the position detection of the support structure or of the printing bed can thereby be further improved or redundant and thus particularly reliable detection can thereby be brought about.

In a further preferred manner, at least one marking of the printing bed can be optically detectable from a side of the support structure facing away from the printing bed. For this purpose, at least one marking of the printing bed can be arranged on a side of the printing bed that faces the support structure. Additionally or alternatively, at least one marking of the support structure can be arranged on a side facing away from the printing bed. Therefore, such a marking can also be detected via a lower-side position detection device and thus contribute to an overall high positional detection accuracy with a simple constructional design.

Furthermore, in a preferred manner, at least one marking of the printing bed can be arranged on a viewing region of the support structure and/or can be optically detectable by the viewing region of the support structure. Therefore, the approximate position of the marking can be predetermined or predefined by arrangement on or above the viewing region of the support structure. Reliable optical detection of the respective marking can then be undertaken through the viewing region starting from a lower side of the support structure or of the printing bed.

According to a still further preferred embodiment, the support structure can be formed at least in sections or completely from a transparent and/or translucent material, in particular from a glass and/or plastic material. The position and/or alignment of the printing bed can be optically detectable at least through a transparent and/or translucent portion of the support structure. In such an embodiment, the respective marking can be protected on the lower side by the transparent and/or translucent portion of the support structure, but nevertheless optically detected.

According to a further preferred embodiment, at least one marking of a printing screen can be optically detectable through a viewing region and/or through a viewing opening of the support structure. Likewise, in general, a marking of a printing screen can be optically detectable by the support structure. For example, optical detectability of the marking of a printing screen through the support structure can also be possible independently of a specially formed viewing region. This is possible, for example, when the support structure is formed at least in sections or completely from a transparent and/or translucent material.

According to a preferred embodiment, the printing bed can have a non-detachable coating, in particular a coating forming the printing surface. The printing bed itself can therefore have a carrier layer and a coating applied to the carrier layer, wherein the surface of the coating can form the printing surface for printing by way of three-dimensional screen printing.

Such a coating can be selected in particular with regard to the three-dimensional screen-printed workpieces to be produced in each case. A coating can contribute to the material to be printed in each case not reacting with the printing bed or to contamination of the screen-printed workpieces being produced. In addition, a coating can ensure that the printed workpieces can subsequently be easily removed from the printing bed.

According to a further preferred embodiment, a separating layer, in particular a separating layer designed as an insulating layer, can be arranged between the printing bed and the support structure. A separating layer can be arranged and/or designed to avoid and/or to reduce the heat transfer between the printing bed and the support structure. In this manner, it can be avoided that the heat energy introduced into the support structure is subsequently transferred to the printing bed, as a result of which subsequent printing processes could be impaired. In particular, as a result of an excessively heated printing bed, the risk can arise that printing layers which have already been printed on and dried liquefy again or assume an inaccurate form.

A separating layer in question here can be fixed between the printing bed and the support structure. The separating layer can be fixed to the support structure independently of the printing bed. It is likewise possible for the separating layer to be fixed to the printing bed independently of the support structure. Secure positioning between the printing bed and the support structure can thereby be maintained.

According to a further preferred embodiment, the separating layer can be arranged loosely between the printing bed and the support structure. Such a separating layer can likewise be fixed by a sandwich arrangement between the printing bed and the support structure. In such an embodiment, it can be dispensed with that the separating layer is fixed directly to the support structure or the printing bed, but rather the respective fixing results from the respective sandwich arrangement. Secure positioning of the separating layer between the printing bed and the support structure can also be maintained in this manner.

The separating layer can particularly preferably be designed as a flexible mat and/or flexible film. This enables simple handling and good positionability between the printing bed and the support structure.

The separating layer can furthermore consist at least in sections or completely of a plastic material, in particular of a polyester material. Such a material is cost-effective to procure and can ensure good insulation properties.

It is likewise possible for the separating layer to consist at least in sections or completely of a ceramic material. Such a ceramic material has a very high heat resistance and is therefore suitable for permanent or at least long-term use.

In a still more preferred manner, the separating layer can be formed from a heat-stabilized and/or high-temperature-resistant material, in particular having a temperature resistance of up to 100° C., preferably up to 150° C., preferably up to 200° C., more preferably up to 250° C. High operational reliability can thereby be achieved, even at relatively high drying temperatures for the respective three-dimensional screen-printed workpieces which are to be produced layerwise on the printing bed.

According to a further preferred embodiment, the printing bed can have a greater thickness than the separating layer, in particular a greater thickness by at least 10%, preferably at least 20%, preferably at least 30%, preferably at least 40%, preferably at least 50% than the separating layer. The separating layer can therefore be designed to be relatively thin. Too much piling in the thickness of the entire arrangement of support structure, printing bed and separating layer can therefore be avoided. An overall compact construction can therefore also be realized in the case of the arrangement of a separating layer.

According to a still more preferred embodiment, the support base of the workpiece carrier can have interruptions and/or openings. In such a configuration, the printing bed would not lie over the full area. A heat input from the support base to the printing bed can be reduced by a contact area between the printing bed and the support base which is reduced in this way.

Further preferably, the support base can have support webs for the partial support of the printing bed. By means of such support webs, a specific mounting of the printing bed can take place at predefined points or along predefined portions. At the same time, the contact area between the support base and the printing bed can be kept small by such support webs. Furthermore, support webs can contribute to improving the structural rigidity of the support base and/or of the entire support structure.

Further preferably, a free space can be formed at least partially between the support base and the printing bed and/or on an underside of the printing bed that faces the support base, in particular a free space extending between support webs and/or between at least one support web and a side wall of the insertion cavity. Likewise, this can be a free space defined by an interruption of the support base. Such a free space ensures a good thermal insulation between the printing bed and the support base or the support structure, with the result that an undesired heating of the printing bed can be avoided as far as possible or at least reduced further.

According to a still further preferred embodiment, the support structure, together with the printing bed fastened thereto, can be designed for temporary positioning within a printing device and/or for temporary fastening and/or for temporary clamping to a conveying vehicle of a 3D screen printing machine. A workpiece carrier designed in this way can therefore be used in a suitable manner for series production by means of 3D screen printing.

In a still further preferred embodiment, the support structure can have predefined contact surfaces for clamping in a workpiece carrier mounting of a conveyor vehicle, in particular of a conveyor vehicle of a 3D screen printing machine. By means of predefined contact surfaces, a high positioning accuracy of the workpiece carrier relative to a conveyor vehicle of a 3D screen printing machine can be achieved, with the result that a high reproducibility can be achieved overall.

In a still further preferred manner, the support structure can have a total of more than two, more than three or three predefined contact surfaces for clamping in a workpiece carrier mounting of a conveyor vehicle. In this case, preferably at least two contact surfaces can be formed on opposite sides of the support structure and/or preferably at least two contact surfaces can be formed on the same side of the support structure. This enables suitable clamping and therefore secure fixing of the support structure in a workpiece carrier mounting of a conveyor vehicle.

According to a further preferred embodiment, the predefined contact surfaces can be formed in sections on an outer circumferential surface of the support structure running between an upper side and a lower side of the support structure. The support structure can therefore be contacted and clamped laterally, with the result that the risk of lateral or lateral incorrect positioning can be kept low.

Further preferably, the predefined contact surfaces can be formed inclined with respect to adjacent sections of the outer circumferential surface. By means of a contact surface of the support structure formed inclined in this way, form-fitting fastening of the support structure and therefore of the entire workpiece carrier within a workpiece carrier mounting can be realized in a particularly simple and advantageous manner. In particular, in the case of a correspondingly designed slide or a correspondingly designed locking means, form-fitting fixing of the support structure can thereby be realized in a simple manner.

The predefined contact surfaces can preferably enclose an angle of more than 90° with an adjacent surface section of an upper side of the support structure. Additionally or alternatively, the predefined contact surfaces can enclose an angle of less than 90° with an adjacent surface section of a lower side of the support structure. By clamping the support structure via such contact surfaces, a hold-down force can therefore be generated, with the result that the workpiece carrier can be securely fixed not only in lateral or horizontal directions, but also in a vertical direction or height direction.

A further independent aspect of the present invention relates to a workpiece carrier, in particular for the production of three-dimensional screen-printed workpieces, having at least one printing bed which has a printing surface to be printed on, and having a support structure which supports the printing bed and is formed separately from the printing bed, wherein the support structure has an insertion cavity for the printing bed, wherein the printing bed is at least partially embedded in the insertion cavity of the support structure and is arranged on a support base of the insertion cavity, and wherein the printing bed is fastened on the support structure.

A still further independent aspect of the present invention relates to a workpiece carrier, in particular for the production of three-dimensional screen-printed workpieces, having at least one printing bed which has a printing surface to be printed on, and having a support structure which supports the printing bed and is formed separately from the printing bed, wherein the support structure has a support base and at least one lateral boundary for the printing bed, wherein the printing bed is arranged on the support base, and wherein at least one lateral movement of the printing bed in the position arranged on the support base is limited by the lateral boundary. As a result of such a configuration, the positioning of the printing bed on the support base can be undertaken with only little effort and high positional accuracy.

A still further independent aspect of the present invention relates to a workpiece carrier, in particular for the production of three-dimensional screen-printed workpieces, having at least one printing bed which has a printing surface to be printed on, and having a support structure which supports the printing bed and is formed separately from the printing bed, wherein the position and/or alignment of the printing bed can be optically detected starting from a side of the support structure facing away from the printing bed.

A still further independent aspect of the present invention relates to a workpiece carrier, in particular for the production of three-dimensional screen-printed workpieces, having at least one printing bed which has a printing surface to be printed on, and having a support structure which supports the printing bed, wherein the support structure has at least one viewing opening which is partially covered in plan view by a corner region and/or edge region of the printing bed, and/or wherein at least one corner and/or edge of the printing bed can be optically detected through a viewing opening of the support structure.

A further independent aspect of the present invention relates to a support structure, in particular for a workpiece carrier described above, having a support base for arranging a printing bed which has a printing surface to be printed on, and having at least one stop for a printing bed arranged on the support base, wherein a printing bed arranged on the support base can be brought to bear against the stop in at least one lateral direction. Additionally or alternatively, a lateral boundary for the printing bed can be provided in the case of a support structure, wherein a printing bed arranged on the support base is limited in at least one lateral movement by such a lateral boundary.

A still further independent aspect of the present invention relates to a support structure, in particular for a workpiece carrier according to one of the preceding aspects, having a support base for arranging a printing bed which has a printing surface to be printed on, and having at least one viewing region through which the position and/or alignment of a printing bed arranged on the support base can be optically detected.

A further independent aspect of the present invention relates to a conveying vehicle, in particular for a device described below for producing three-dimensional screen-printed workpieces, having a workpiece carrier mounting and having a workpiece carrier described above, wherein the workpiece carrier is mounted and/or fastened in the workpiece carrier mounting.

The present invention likewise relates to a conveying vehicle, in particular for an apparatus for producing three-dimensional screen-printed workpieces, having a workpiece carrier mounting in which a workpiece carrier described above can be mounted and/or fastened.

A further independent aspect of the present invention relates to an apparatus for producing three-dimensional screen-printed workpieces, in particular a 3D screen printing machine, having a printing device for the layerwise production of at least one screen-printed workpiece in a plurality of printing operations and having a transport device for the automated transport of at least one workpiece carrier described above towards and/or away from the printing device, wherein the transport device preferably has at least one transport rail and a conveying vehicle which is arranged movably on the transport rail and has the workpiece carrier.

According to a further preferred embodiment, the transport device can be configured for the automated transport of at least one screen-printed workpiece and/or of a workpiece carrier towards and/or away from a printing table of the printing device. Such a printing table can have, in particular, a printing table plate.

A printing table or a printing table plate can advantageously be brought into contact with an underside of a workpiece carrier for carrying out a printing operation and support said workpiece carrier during the printing operation. A printing table or a printing table plate therefore preferably does not serve for direct printing or as a direct printing base or for providing a surface to be printed on. Rather, a printing table or a printing table plate can advantageously be designed and/or arranged for temporarily contacting, lifting and/or supporting a workpiece carrier.

According to a preferred embodiment of the present invention, the apparatus can be designed and/or configured for production under clean-room conditions. In particular, the apparatus can be designed and/or configured for production under clean-room conditions according to the clean-room classes A, B, C and/or D according to EU-GMP.

Furthermore, an apparatus according to the invention can be designed and/or configured for producing screen-printed workpieces for application in medical technology, in optical and/or laser technology, in aerospace technology, in semiconductor technology, in biotechnology and/or in medical and/or in pharmacological research.

Likewise, the apparatus according to the invention can be designed and/or configured for producing screen-printed workpieces for use and/or application as medical and/or pharmaceutical products, implants and/or sterile products and/or medicaments and/or for use and/or application as tablets for active ingredient administration.

A further independent aspect of the present invention relates to an apparatus for producing three-dimensional screen-printed workpieces, in particular 3D screen printing machine, having a printing device for the layerwise production of at least one screen-printed workpiece in a plurality of printing operations and having at least one workpiece carrier according to one of the preceding aspects, wherein the workpiece carrier can be temporarily positioned within the printing device for carrying out a printing operation and wherein the printing device has a position detection device for the printing bed of the workpiece carrier.

A still further independent aspect of the present invention relates to a printing device, in particular for an apparatus described above, having a printing superstructure having a printing screen, having a printing table plate on which a workpiece carrier can be temporarily positioned and/or fixed for carrying out a printing operation and/or by means of which a workpiece carrier can be contacted on the underside, and having a position detection device for detecting the position of the printing bed of a workpiece carrier positioned on the printing table plate.

A further independent aspect of the present invention relates to a method for producing a three-dimensional screen-printed workpiece, in particular a pharmaceutical product, and/or with an apparatus according to one of the preceding aspects, in which method at least one screen-printed workpiece is produced layerwise on a workpiece carrier described above in a plurality of printing operations by means of a printing device and/or by means of an apparatus described above for producing three-dimensional screen-printed workpieces, and in which method the workpiece carrier with a screen-printed workpiece is transported in an automated manner towards and/or away from the printing device by means of a transport device.

A still further independent aspect of the present invention relates to a method for producing a three-dimensional screen-printed workpiece, in particular a pharmaceutical product, and/or with an apparatus according to one of the preceding aspects, in which method at least one screen-printed workpiece is produced layer-wise in a plurality of printing operations in a printing device, in which method a workpiece carrier according to one of the preceding aspects is temporarily arranged within the printing device for carrying out a printing operation and in which method a position detection device of the printing device carries out a position detection of the printing bed of the workpiece carrier.

A still further independent aspect of the present invention relates to a use of a workpiece carrier according to the preceding description for producing a pharmaceutical product, in particular for producing tablets by means of three-dimensional screen printing.

A still further independent aspect of the present invention relates to a pharmaceutical product, in particular a tablet, produced using a workpiece carrier described above and/or a conveying vehicle described above and/or an apparatus described above for producing three-dimensional screen-printed workpieces and/or using a method described above.

The details and independent aspects described above in relation to the workpiece carrier also apply in the same manner to a support structure described above, to a conveying vehicle described above and also to an apparatus according to the invention for producing three-dimensional screen-printed workpieces. Likewise, the details and independent aspects described above in relation to the workpiece carrier also apply in the same manner to the independent aspects described above in relation to a method for producing a three-dimensional screen-printed workpiece, the use of a workpiece carrier and also in relation to a pharmaceutical product according to the present invention.

The invention is described below by way of example on the basis of advantageous embodiments with reference to the appended figures.

It is shown in each case schematically:

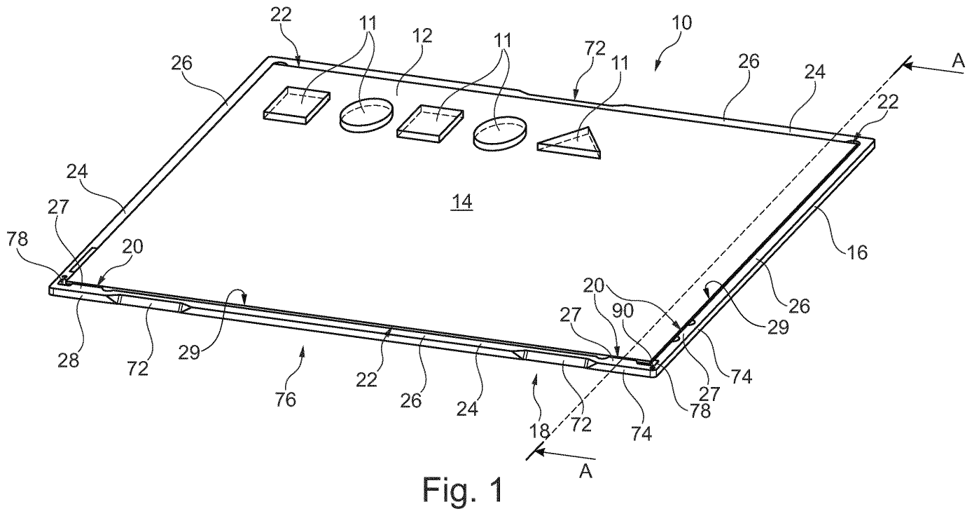

FIG. 1 a perspective view of a workpiece carrier according to the invention according to an embodiment of the present invention,

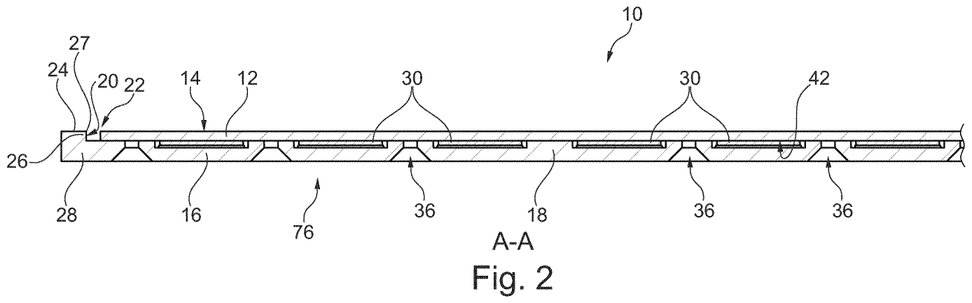

FIG. 2 a sectional illustration of the workpiece carrier along the section line A-A of FIG. 1,

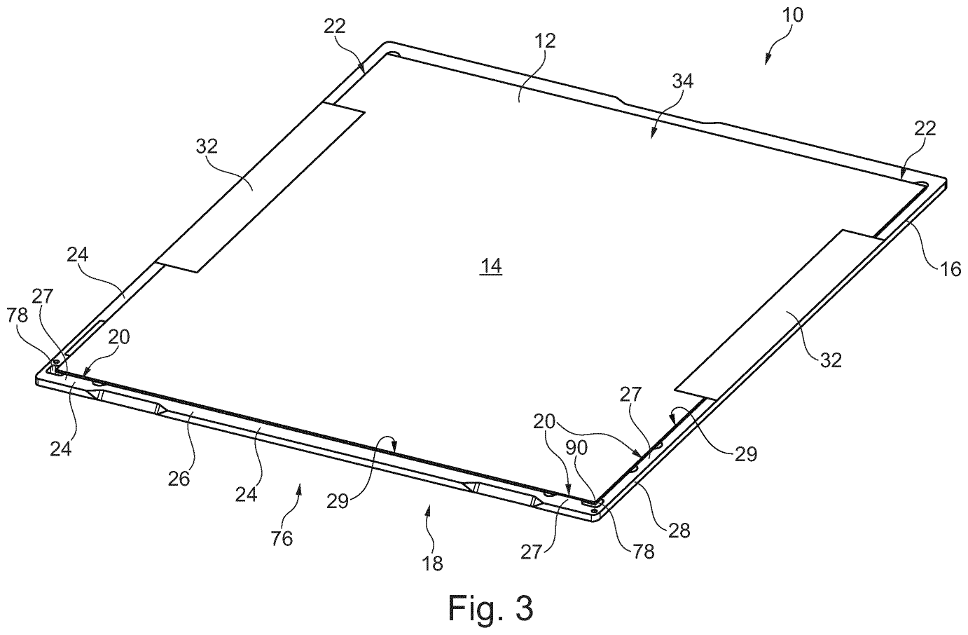

FIG. 3 a perspective view of a workpiece carrier according to the invention according to a further embodiment,

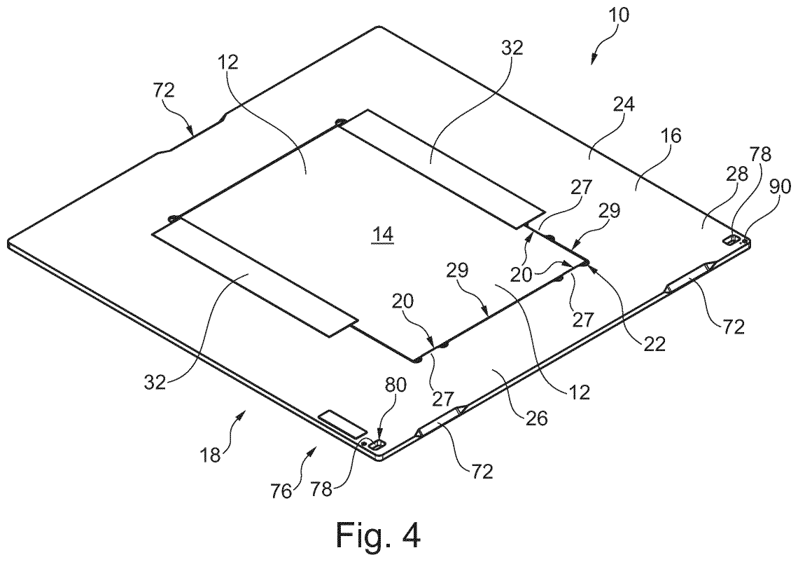

FIG. 4 a perspective view of a workpiece carrier according to the invention according to yet a further embodiment,

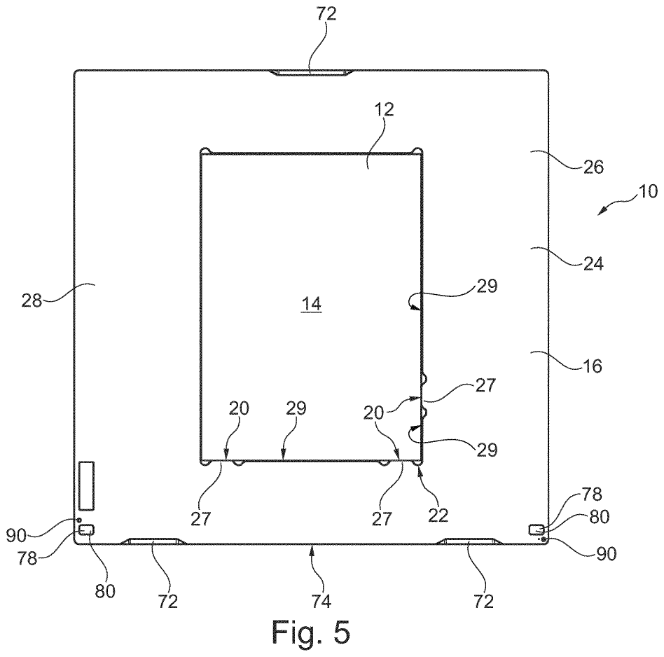

FIG. 5 a plan view of a workpiece carrier according to FIG. 4,

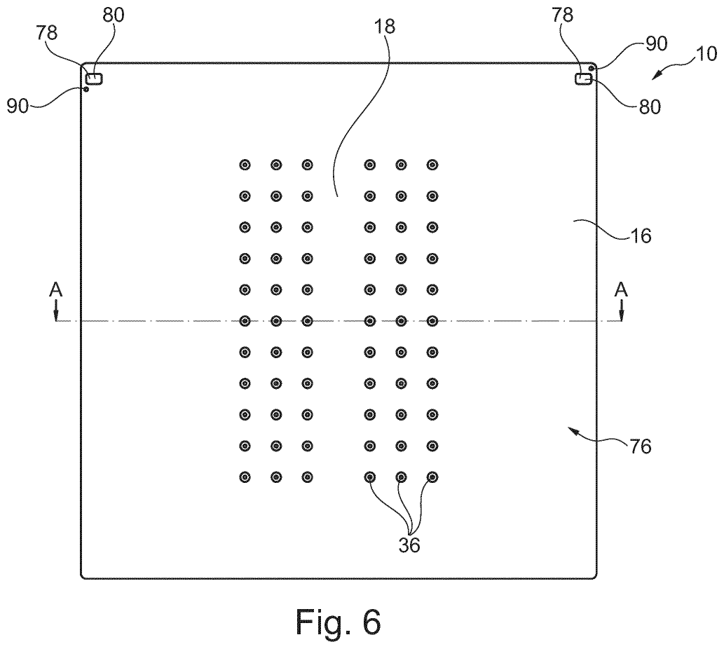

FIG. 6 a bottom view of a workpiece carrier according to FIGS. 4 and 5,

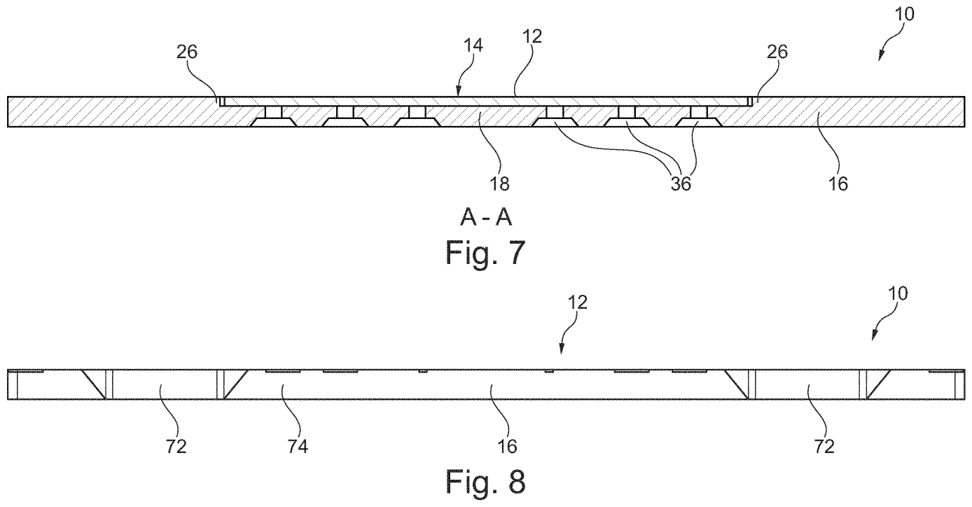

FIG. 7 a sectional illustration along the section line A-A of FIG. 6,

FIG. 8 a side view of a workpiece carrier according to FIGS. 4 to 6,

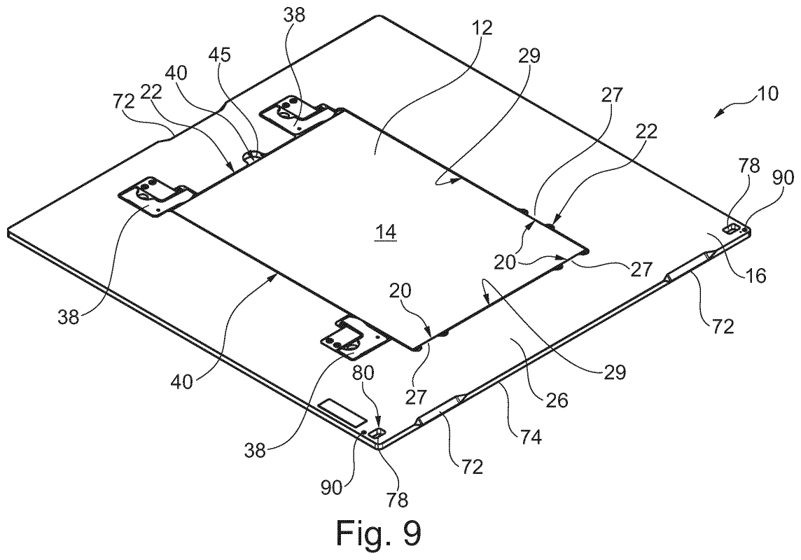

FIG. 9 a perspective view of a workpiece carrier according to the invention according to yet a further embodiment,

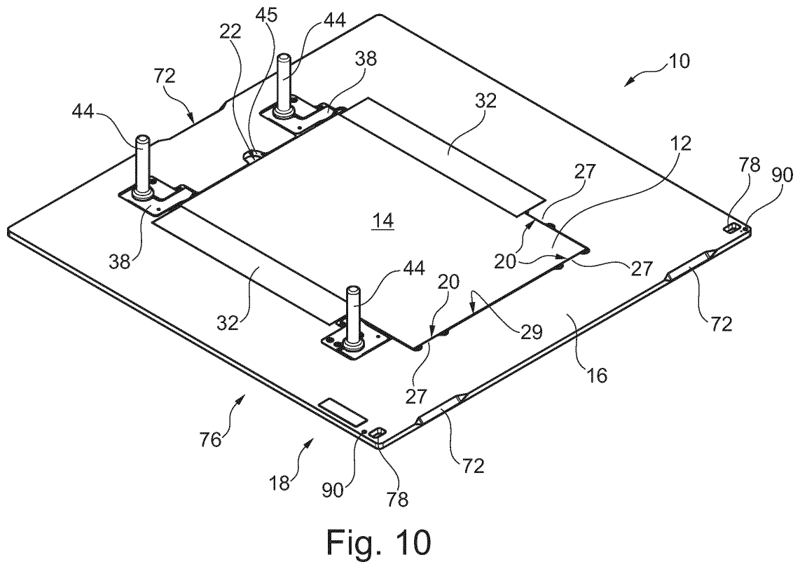

FIG. 10 a perspective view of the workpiece carrier according to FIG. 9 with tools arranged thereon for actuating spring devices for restraining and/or clamping the printing bed,

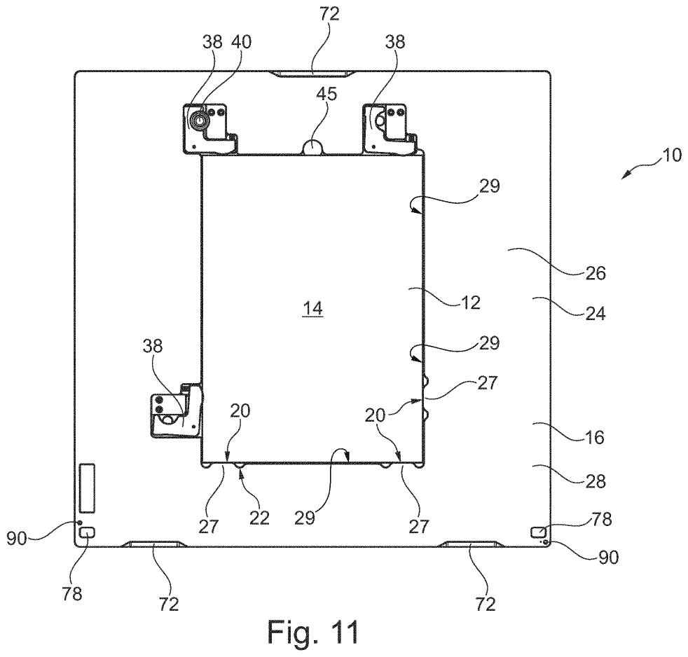

FIG. 11 a plan view of a workpiece carrier according to FIGS. 9 and 10,

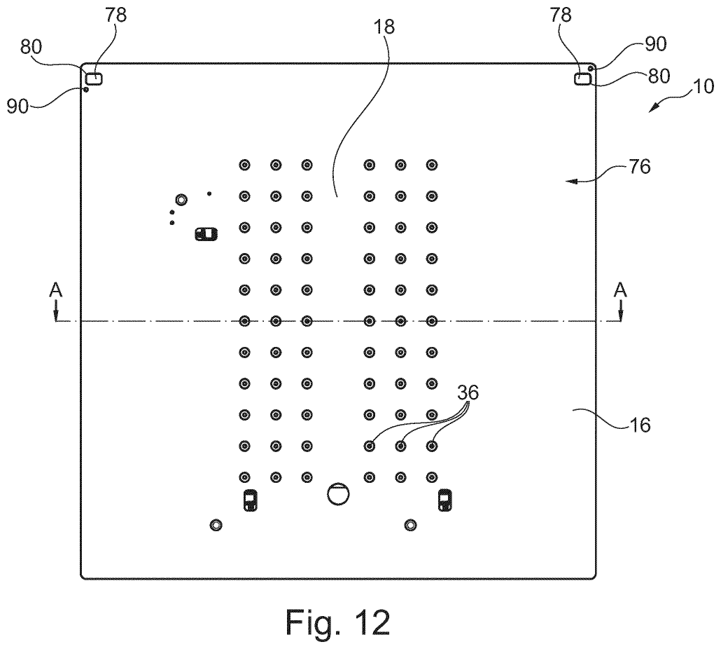

FIG. 12 a bottom view of a workpiece carrier according to FIGS. 9 to 11,

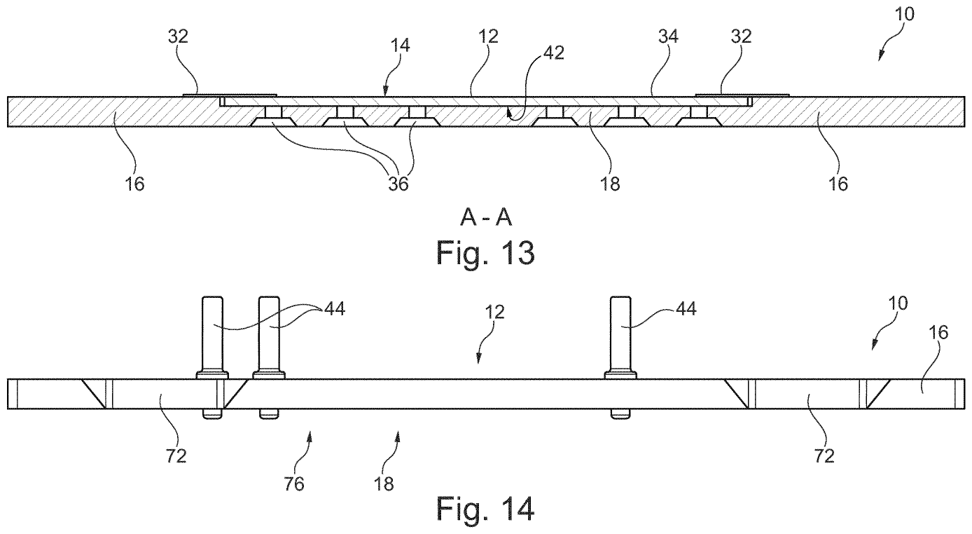

FIG. 13 a sectional illustration of a workpiece carrier according to FIGS. 9 to 12,

FIG. 14 a side view of a workpiece carrier according to FIG. 10 with tools arranged thereon,

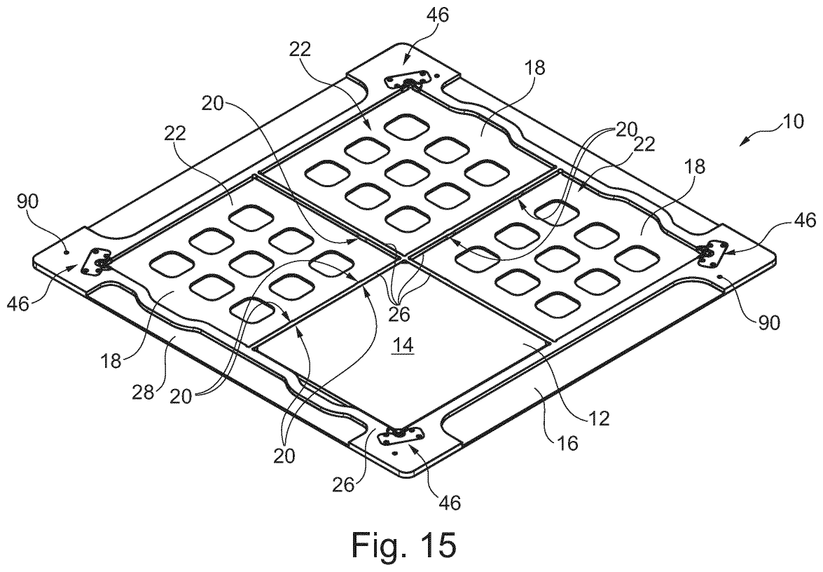

FIG. 15 a perspective view of a workpiece carrier according to the invention according to yet a further embodiment,

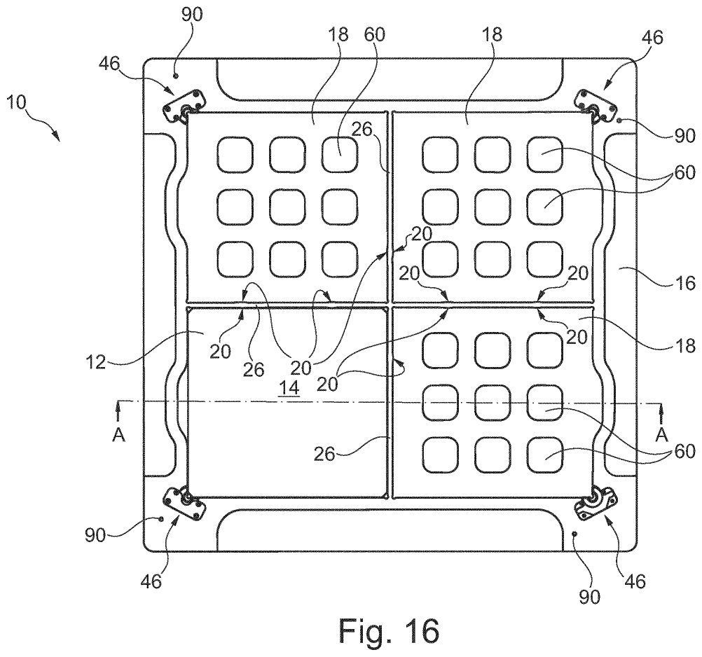

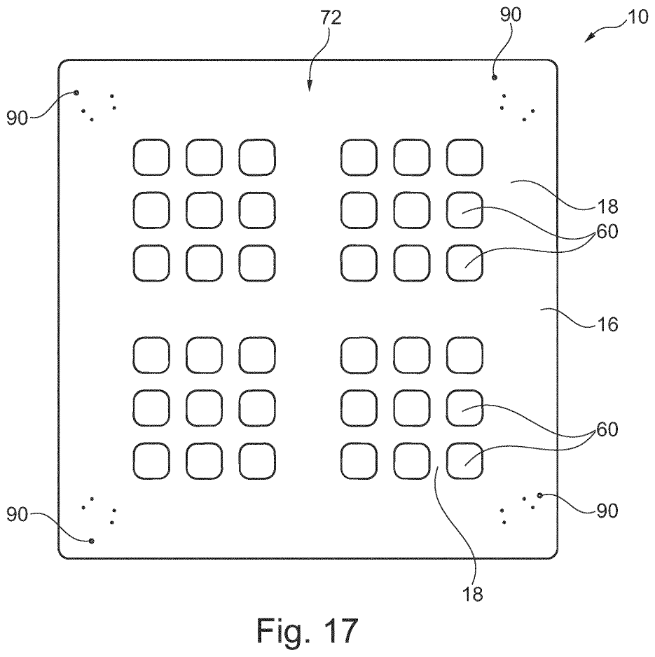

FIG. 16 a plan view of a workpiece carrier according to FIG. 15,

FIG. 17 a bottom view of a workpiece carrier according to FIGS. 15 and 16,

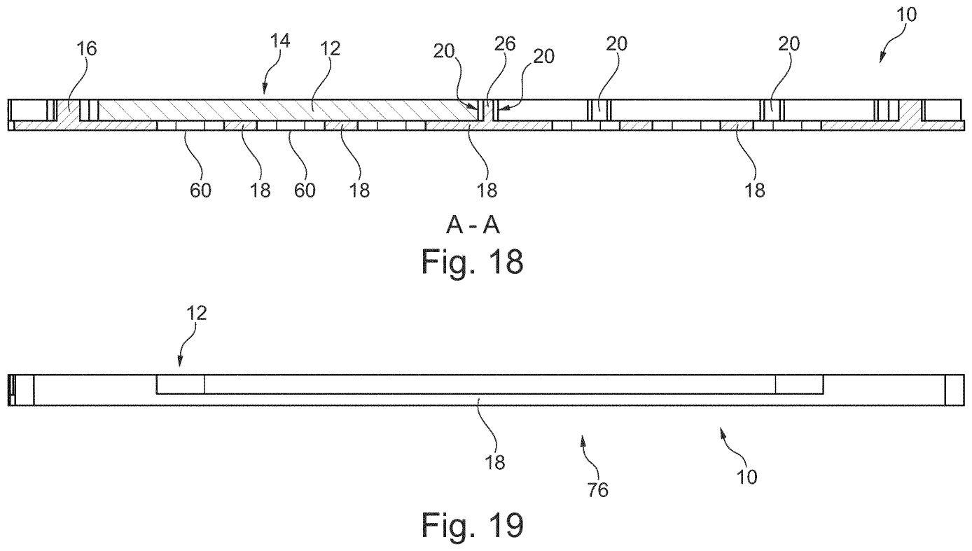

FIG. 18 a sectional illustration along the section line A-A of FIG. 16,

FIG. 19 a side view of a workpiece carrier according to FIGS. 15 to 18,

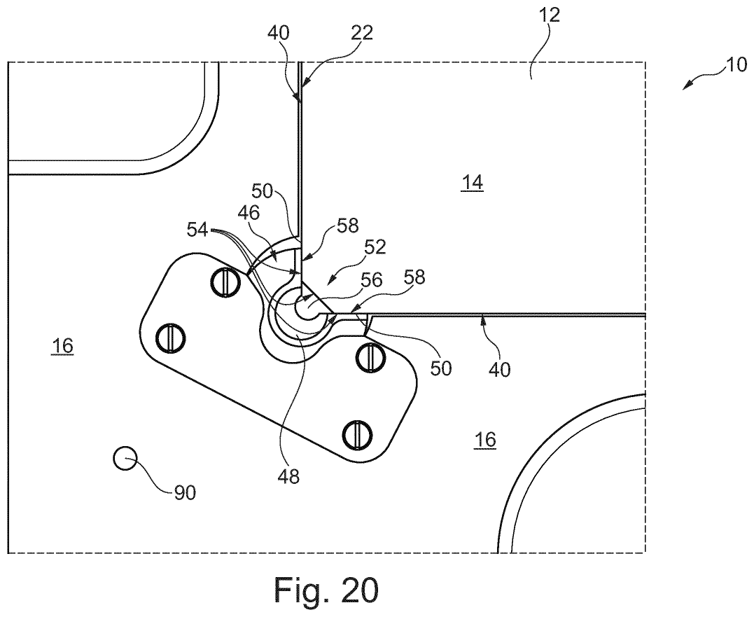

FIG. 20 a detail view of a workpiece carrier according to FIGS. 15 to 19,

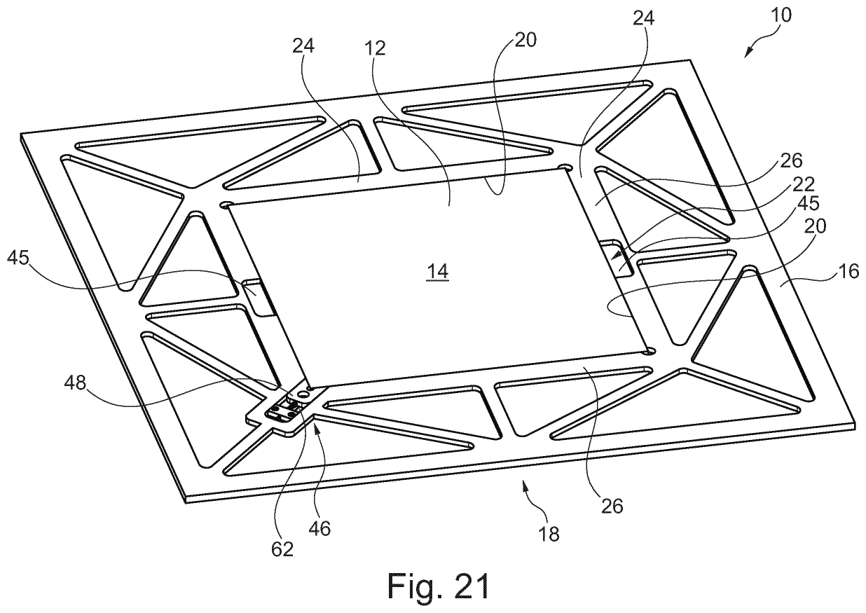

FIG. 21 a perspective view of a workpiece carrier according to the invention according to yet a further embodiment,

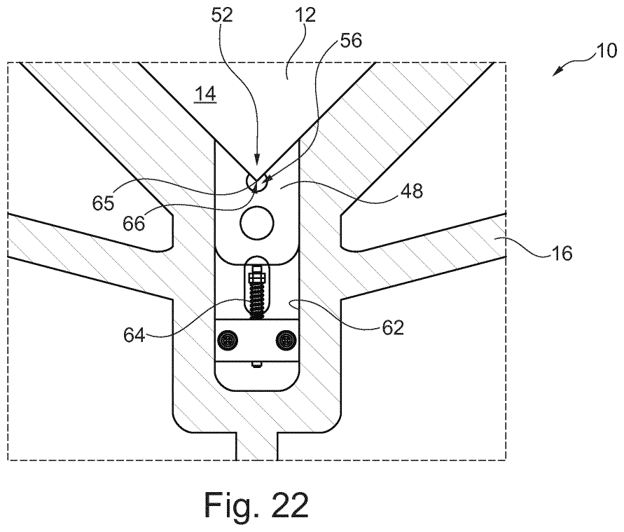

FIG. 22 a detail view of a workpiece carrier according to FIG. 21,

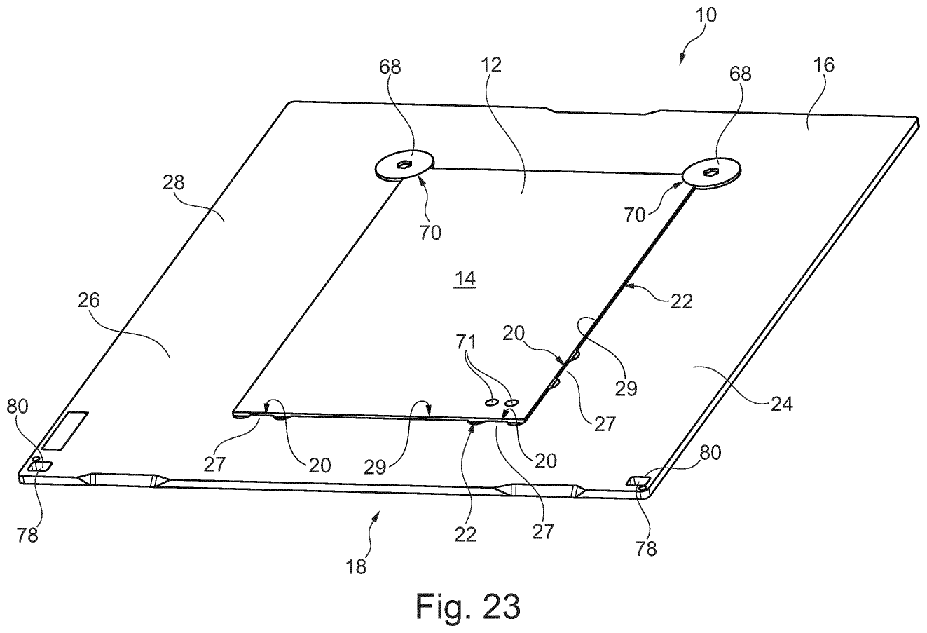

FIG. 23 a perspective view of a workpiece carrier according to the invention according to yet a further embodiment,

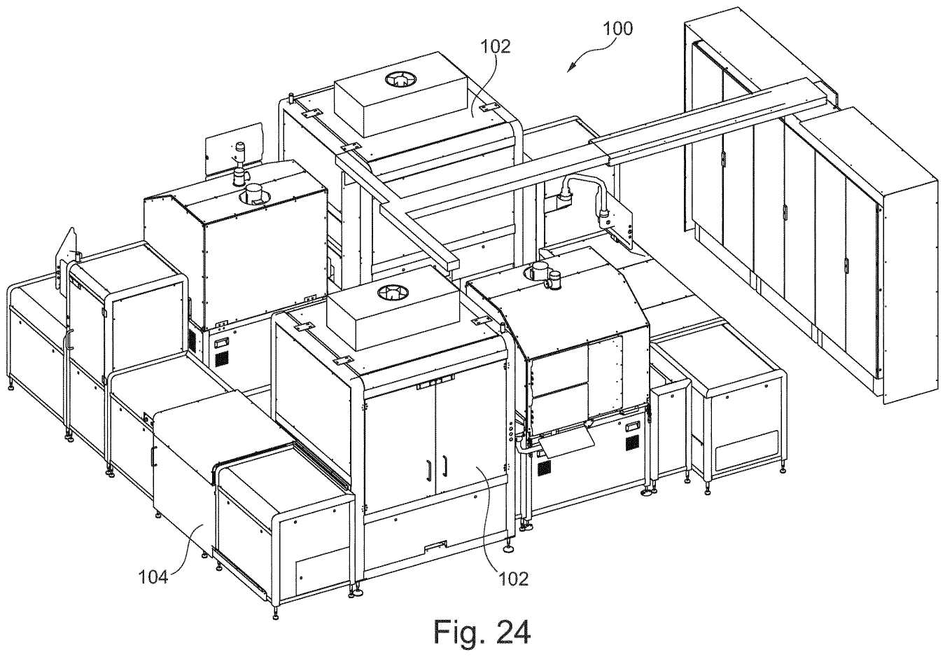

FIG. 24 a perspective view of a device according to the invention for producing three-dimensional screen-printed workpieces according to an embodiment,

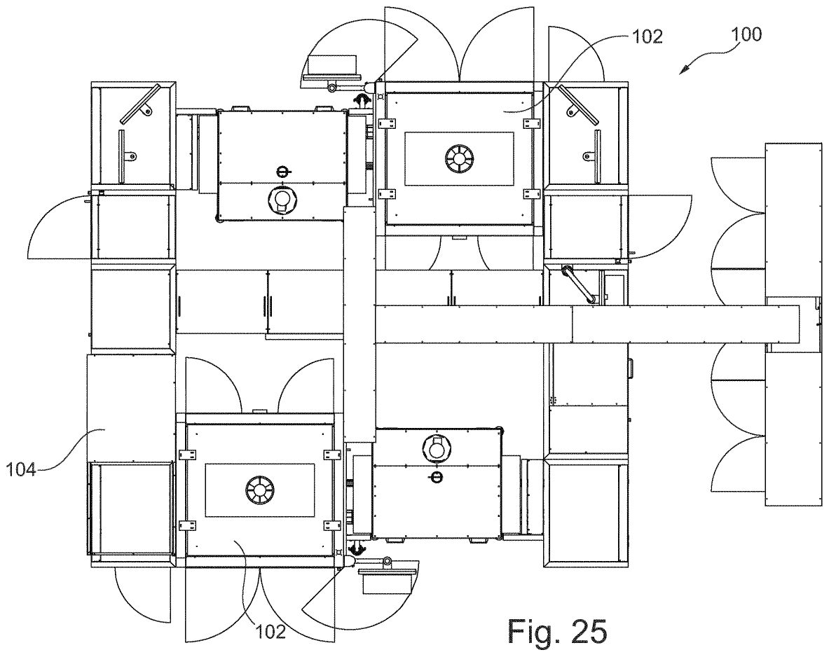

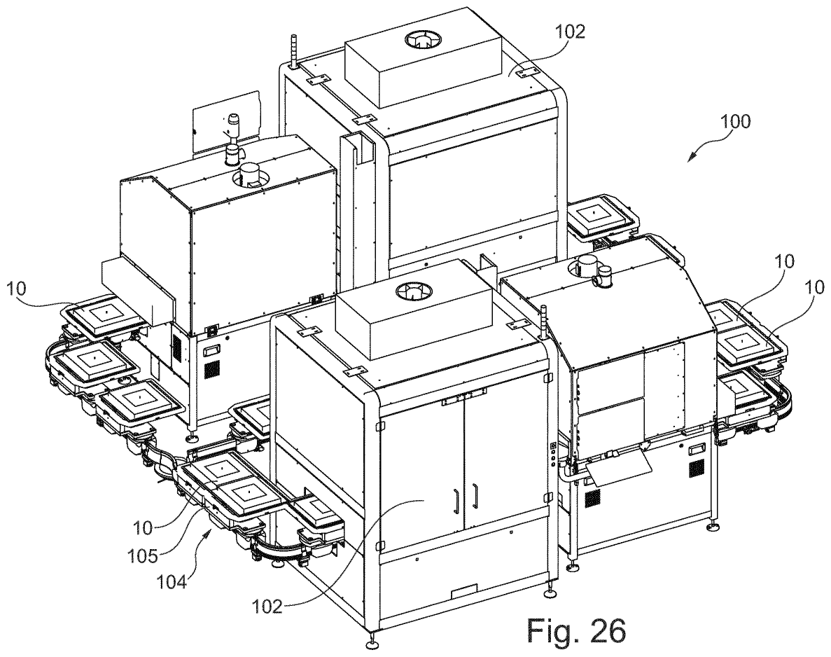

FIG. 25 a plan view of the device of FIG. 1,

FIG. 26 a perspective view of the device of FIG. 1 with open representation of the transport device without housing,

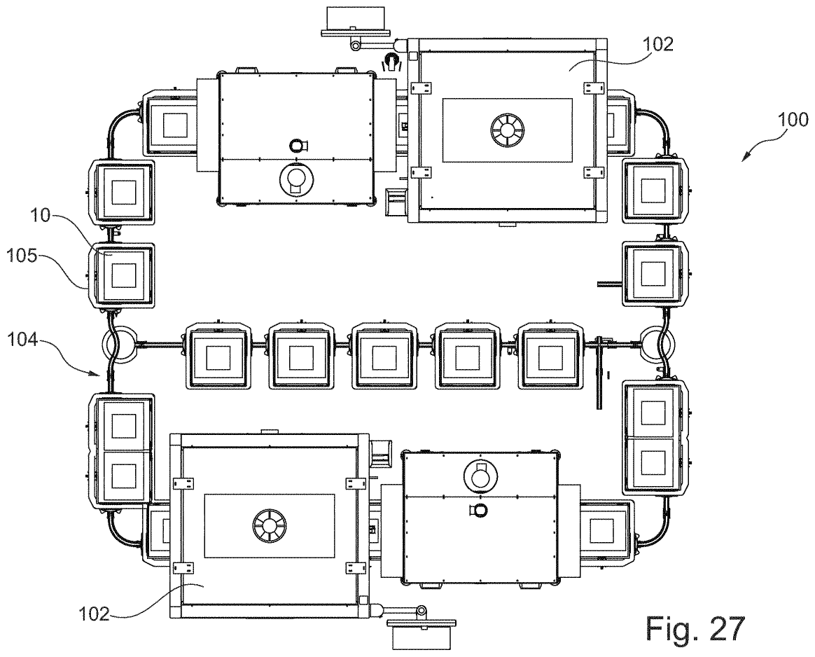

FIG. 27 a plan view of the device of FIG. 32,

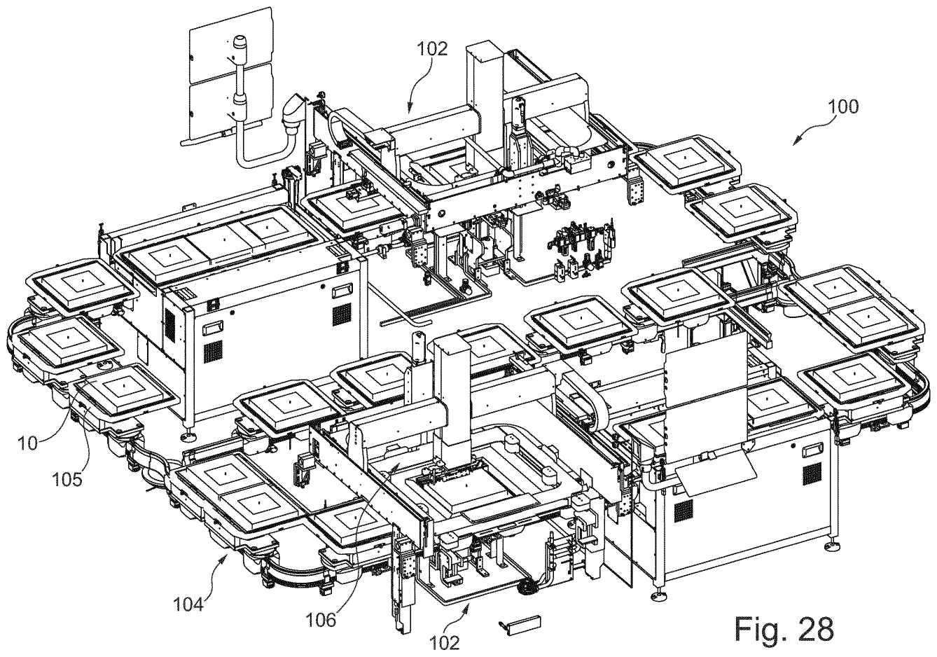

FIG. 28 a perspective view of a device according to the invention with open representation of the printing and drying devices without housing,

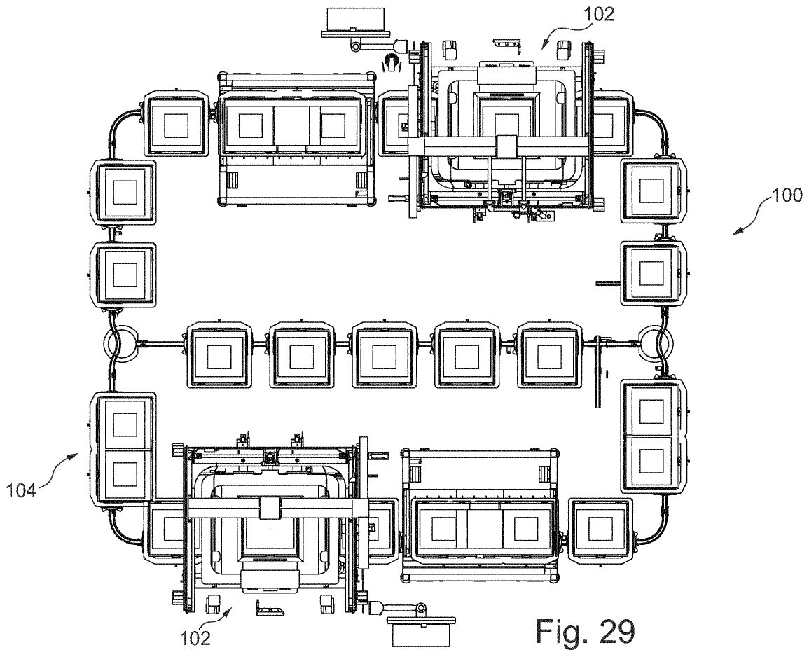

FIG. 29 a plan view of the device of FIG. 28,

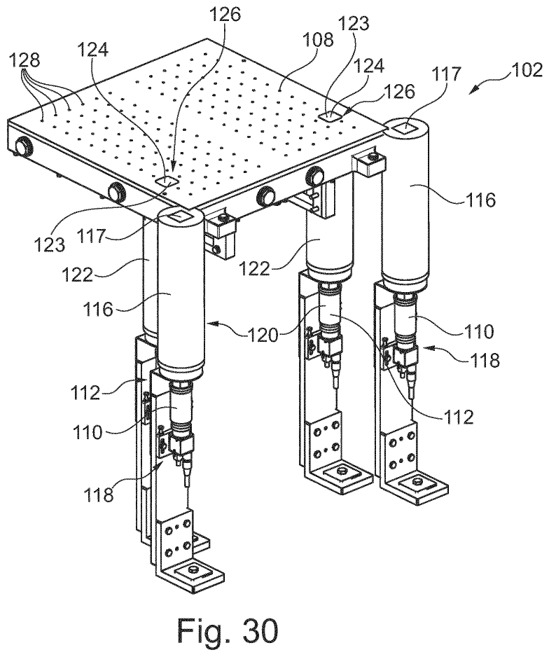

FIG. 30 a perspective view of a part of a printing device according to an embodiment,

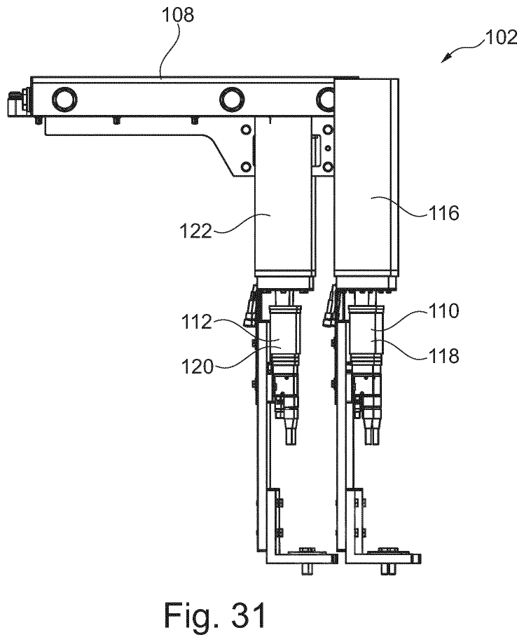

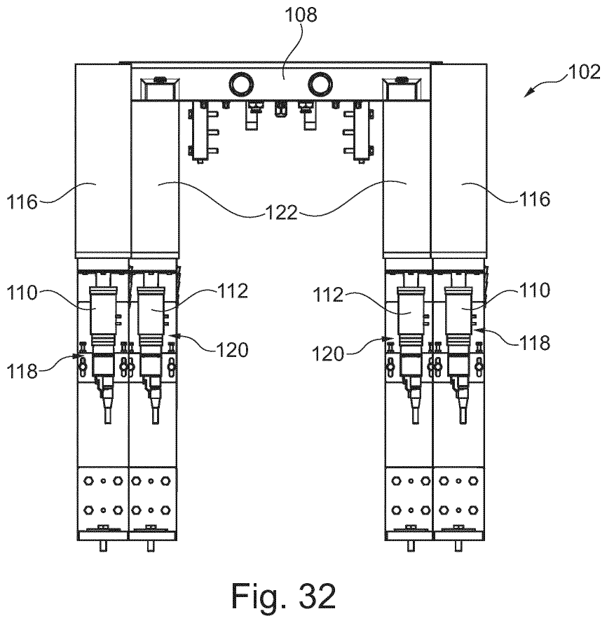

FIG. 31 a side view of the printing device according to FIG. 30,

FIG. 32 a further side view of the printing device according to FIGS. 30 and 31,

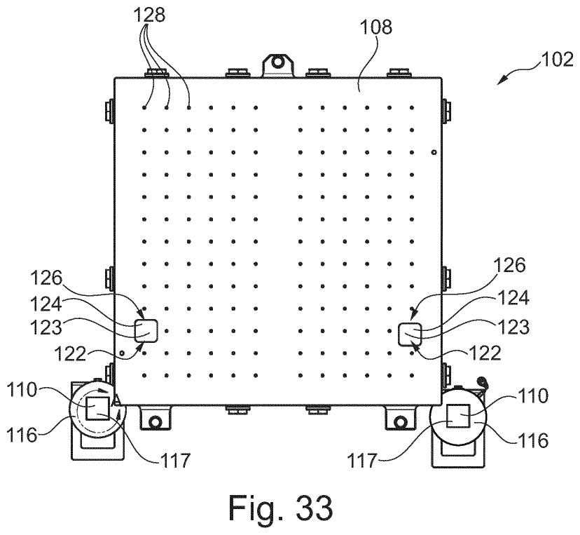

FIG. 33 a plan view of the printing device according to FIGS. 30 to 32,

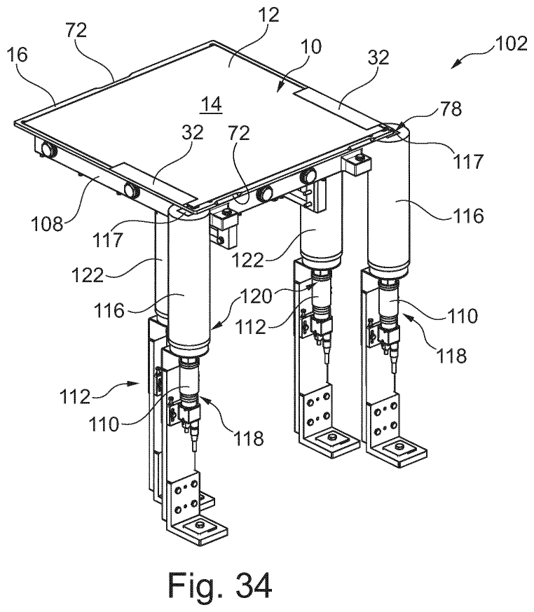

FIG. 34 a perspective view of a part of a printing device according to FIGS. 30 to 33 with a workpiece carrier arranged thereon according to an embodiment of the present invention,

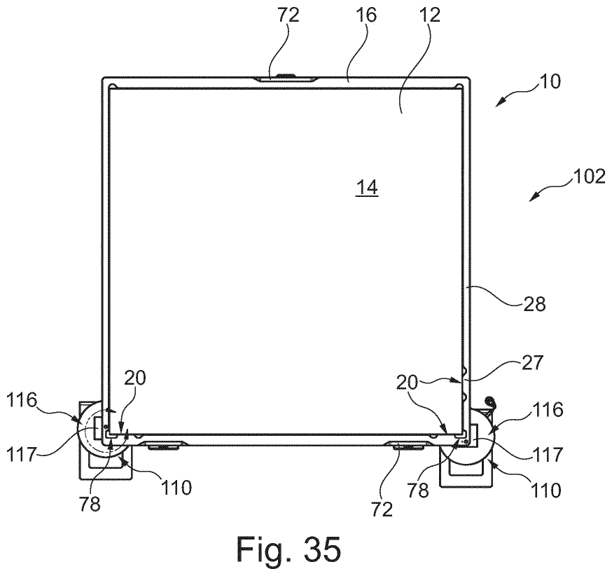

FIG. 35 a plan view of the printing device according to FIG. 34 with a workpiece carrier arranged thereon,

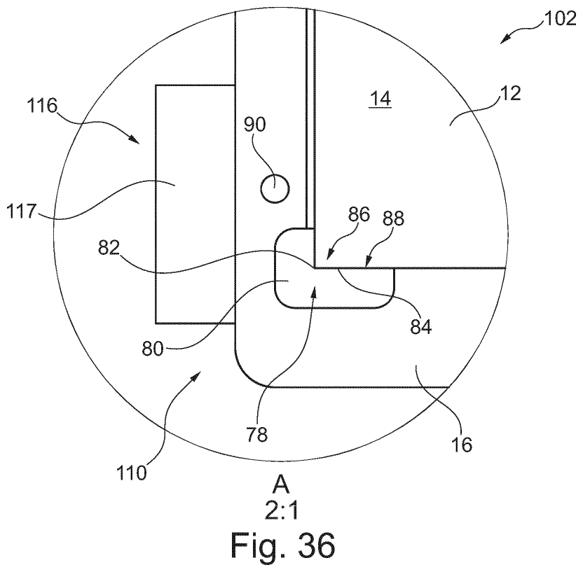

FIG. 36 a detail view A according to FIG. 35,

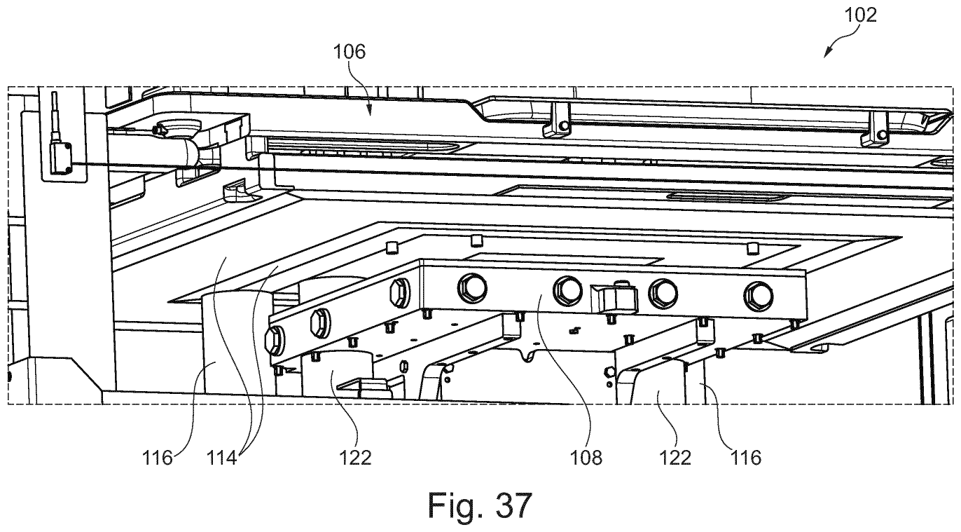

FIG. 37 a perspective view of a printing device without a workpiece carrier arranged thereon.

FIG. 1 shows a perspective view of a workpiece carrier 10 according to an embodiment of the present invention. The workpiece carrier 10 is designed in particular for producing three-dimensional screen-printed workpieces 11, which are illustrated here by way of example in schematic forms. A workpiece carrier 10 is suitable in particular for producing pharmaceutical products, in particular medicaments or tablets, by means of 3D screen printing. FIG. 2 shows a sectional illustration of the workpiece carrier 10 of FIG. 1 along the section line A-A.

The workpiece carrier 10 has at least one printing bed 12 which forms a printing surface 14 to be printed on. Consequently, the upper-side surface of the printing bed 12 can be a printing surface 14 to be printed on. Three-dimensional screen-printed workpieces 11 can be produced layerwise in a plurality of printing operations on the printing surface 14 by means of 3D screen printing.

Furthermore, the workpiece carrier 10 has a support structure 16 which supports the printing bed 12 and is formed separately from the printing bed 12. The support structure 16 has a support base 18 on which the printing bed 12 is arranged. The printing bed 12 can lie on the support base 18.

Furthermore, the support structure 16 has at least one stop 20 for the printing bed 12, wherein, in the positions arranged on the support base 18, the printing bed 12 can be brought to bear against the stop 20 in at least one lateral direction. In the representation shown in FIG. 2, for better visibility, the printing bed 12 is spaced apart from the stop 20 in the lateral direction, but can be brought to bear against the stop 20. In a position of the printing bed 12 brought to bear against the stop 20, the position thereof can be fixed with relatively high accuracy relative to the support structure 16, at least in a lateral direction.

As is illustrated in FIGS. 1 and 2, the support structure 16 can have an insertion cavity 22 for the printing bed 12. The printing bed 12 can be embedded at least in sections in the insertion cavity 22, preferably completely embedded in the insertion cavity 22. In particular, the printing surface 14 of the printing bed 12 can be aligned flush with surface sections 24 of the upper side of the support structure 14, wherein the surface sections 24 surround the insertion cavity 22.

The insertion cavity 22 can be delimited at least in sections by the support base 18, by one or more side walls 26 or by the at least one stop 20. In particular, in an embodiment with an insertion cavity 22, the at least one stop 20 can be formed by or on a side wall 26 of the insertion cavity 22. The at least one stop 20 can preferably be formed by a side projection 27 of a side wall 26 of the insertion cavity 22.

The support structure 14 can have overall a plurality of stops 20 for the printing bed 12. The support structure 14 can have overall a plurality of stops 20 formed as side projections 27 of a side wall 26 or a plurality of side walls 26. In the position arranged on the support base 18, the printing bed 12 can be brought to bear in a plurality of lateral directions against a plurality of stops 20. Preferably, the support structure can have precisely three stops 20 or precisely three stops 20 formed as side projections 27 of a plurality of side walls 26.

As can be seen from the embodiment in FIGS. 1 and 2, one of the stops 20 can be formed on a side wall 26 of the insertion cavity 22 and two further stops 20 can be formed on a neighboring side wall 26 of the insertion cavity. Likewise, in each case one stop 20 can be formed on in each case one side wall 26 of the insertion cavity 22. Adjacent and/or opposite side walls 26 of the insertion cavity 22 can therefore form different stops 20.

Furthermore, a clearance section 29 can be formed between the printing bed 12 and a side wall 26 of the insertion cavity 22. Such a clearance section 29 can be formed, in particular, as a gap between the printing bed 12 and a side wall 26 of the insertion cavity 22. Along a clearance section 29, the printing bed 12 can be free of a contacting of the respective side wall 26 of the insertion cavity 22.

In this case, a clearance section 29 can extend between two stops 20 of a side wall 26 of the insertion cavity 22 or between two side projections 27 of a side wall 26 of the insertion cavity 22. Likewise, a clearance section 29 can extend adjacent to a stop 20 or adjacent to a side projection 27 of a side wall 26 of the insertion cavity 22. In the case of such an extension, the clearance section is likewise formed between the side surface of the printing bed 12 and the respective side wall 26 of the insertion cavity 22.

A plurality of stops 20 can be formed in a preferred manner by a single shaped body. Such a shaped body can form, for example, a plurality of side walls 26 of the insertion cavity 22. In such an embodiment, a plurality of side walls 26 can be formed integrally with one another.

The support structure 16 can preferably have a frame section 28 which is connected to the support base 18. The frame section 28 can have a greater thickness than the support base 18. In this case, the at least one stop 20 can be formed and/or arranged on the frame section 28. In particular, the frame section 28 can have or form at least one side wall 26 of the insertion cavity 22. Accordingly, the insertion cavity 22 can be delimited at least in sections by the frame section 28 and the support base 18. All side walls 26 of the insertion cavity 22 can preferably be formed on the frame section 28. Consequently, the side projections 27 formed on the respective side walls 26 can also be formed on the frame section 28.

In a still further preferred manner, the frame section 28 and the support base 18 can be designed to be connected to one another in one piece.

Alternatively, the support base 18 can also be formed separately from the frame section 28 and fastened to the latter, which is not illustrated in more detail here. In the case of such a fastening, the support base 18 can be fastened to the frame section 28 in a floating manner, in particular in order to compensate for temperature-induced expansion behavior of the support base 18 relative to the frame section 28.

The at least one stop 20 or the stop 20 designed as a side projection 27 of a side wall 26 can preferably be designed as a side boundary for the printing bed 12. In particular, a plurality of stops 20 can form a plurality of side boundaries for different sides of the printing bed 12. In this case, the at least one stop 20 can be designed for flat contact of the printing bed 12 in a lateral direction, in particular on a contact surface of the stop 20. A stop 20 designed as a side boundary can particularly preferably delimit an entire side of the printing bed 12 or a side section of the printing bed 12 and thus enable particularly secure contact of the printing bed 12 in the lateral direction.

The stop 20 can extend relative to the support base 18 along a thickness direction of the support structure 16 and/or along a thickness direction of the printing bed 12. The height of the stop 20 relative to the support base 18 in a thickness direction of the support structure 16 and/or in a thickness direction of the printing bed 12 can be dimensioned to be less than or equal to the thickness of the printing bed 12. Consequently, the printing surface 14 of the printing bed 12 can be aligned flush with surface sections 24 of the upper side of the support structure 16, as has been described above in relation to the complete embedding of the printing bed 12 in the insertion cavity 22.

In a further preferred manner, the printing bed 12 can be fastened to the support structure 16. The printing bed 12 can be fastened in particular in a force-fitting and/or form-fitting and/or material-bonded manner to the support structure 16 and/or within the insertion cavity 22 of the support structure 16. The fastening of the printing bed 12 to the support structure 16 can be provided or undertaken in particular at a position bearing in a lateral direction against at least one stop 20 or a plurality of stops 20.

In the embodiment according to FIGS. 1 and 2, the printing bed 12 can be magnetically fastened to the support structure 16 or within the insertion cavity 22. The printing bed 12 can be fastened to the support structure 16 and/or within the insertion cavity 22 at least by a magnetic film 30. A magnetic film 30 can be adhesively bonded, for example, to the support base 18 and/or embedded and/or adhesively bonded in the support base 18, as results in particular from FIG. 2.

If the printing bed 12 consists of a magnetic material, a force-fitting fastening of the printing bed 12 to the support structure 16 can be undertaken via the magnetic films 30. It is likewise possible for magnetic films 30 to be arranged or adhesively bonded in turn to the underside of the printing bed 12. Such magnetic films 30 fastened to the underside of the printing bed 12 can interact with a magnetic material of the support structure 18 and/or with magnetic films 30 which are arranged or adhesively bonded to the support structure 16.

Instead of magnetic films 30, so-called neodymium magnets which can ensure a particularly high holding force can also be used for the fastening of the printing bed 12 to the support structure 16.

FIG. 3 shows a perspective view of a workpiece carrier 10 according to a further embodiment of the present invention. In the embodiment according to FIG. 3, the printing bed 12 is likewise embedded in an insertion cavity 22 of the support structure 16. In this case, the printing bed 12 is adhesively bonded to the support structure 16 and/or within the insertion cavity 22. Such a fastening can be undertaken in particular by an adhesive tape 32. In particular, a fastening by means of adhesive tape 32 can be provided at opposite ends of the printing bed 12. For this purpose, the adhesive tape 32 can be adhesively bonded to the printing bed 12 and the support structure 16 in an overlapping manner on an upper side 34 of the printing bed 12 that faces away from the support base 18. The adhesive tape 32 can consequently extend over a section of the printing surface 14 or the upper side 34 of the printing bed 12 and also over surface sections 24 of the upper side of the support structure 16 and thereby ensure simple and robust fixing of the printing bed 12 to the support structure 16.

Additionally or alternatively, an adhesive tape for adhesively bonding the printing bed 12 to the support structure 16 can also be provided between the printing bed 12 and the support base 18 of the support structure 16, which is not illustrated in more detail here.

FIGS. 4 to 8 show a workpiece carrier 10 according to yet a further embodiment of the present invention. In the embodiment according to FIGS. 4 to 8, fastening of the printing bed 12 to the support structure 16 is likewise realized by means of adhesive tapes 32. In contrast to the embodiment in FIG. 3, in the embodiment according to FIGS. 4 to 8, the printing bed 12 is designed to be significantly smaller relative to the support structure 16. The frame section 28 of the support structure 16 thus has wider side walls 26 than in the embodiment according to FIG. 3. Accordingly, the support base 18 is dimensioned to be relatively smaller in the embodiment according to FIGS. 4 to 8 than in the embodiment according to FIG. 3.

As illustrated in FIGS. 2, 6 and 7, the support base 18 can have at least one through-bore suction opening 36, in particular a plurality of suction openings 36. A negative pressure can be applied to the printing bed 12 through the suction openings 36 or suctioning of the underside of the printing bed 12 can be undertaken via such a suction opening 36 for temporary fixing within a printing device of a 3D screen printing machine, which printing device will be described in more detail below.

FIGS. 9 to 14 show a further embodiment of a workpiece carrier 10 according to the present invention. In the embodiment according to FIGS. 9 to 14, the printing bed 12 is fixedly clamped to the support structure 16 and/or within the insertion cavity 22 by at least one spring device 38. The printing bed 12 can be clamped and/or tensioned laterally against at least one stop 20 or against at least one side wall 26 and/or against a side projection 27 of a side wall 26 of the insertion cavity 22 by the at least one spring device 38. In particular, a plurality of spring devices 38 can be provided by which the printing bed 12 is fixedly clamped to the support structure and/or within the insertion cavity 22 and/or against at least one stop 20 or against a plurality of stops 20 or against a plurality of side walls 26 of the insertion cavity 22 or against a plurality of side projections 27.

For this purpose, the at least one spring device 38 can act laterally on the printing bed 12, in particular on a side surface 40 of the printing bed 12 which extends between the upper side 34 of the printing bed 12 that faces away from the support base 18 and the underside 42 of the printing bed 12 that faces the support base 18. In a particularly advantageous manner, a plurality of spring devices 38 can act laterally on the printing bed 12, namely on a plurality of mutually adjacent side surfaces 40 of the printing bed 12.

The spring devices 38 can, in particular, be tensioned and/or released in a tool-based manner. In particular, the spring devices 38 can be tensioned and/or released exclusively in a tool-based manner. A schematic illustration of the tools 44 to be used for tensioning and/or releasing can be gathered from FIGS. 10 and 14.

Furthermore, the support structure 16 can have a grip recess 45 via which a side surface 40 of the printing bed can be manually contacted in an arrangement positioned in the insertion cavity 22. The grip recess 45 can be dimensioned such that an operator can carry out a lateral contacting of the printing bed 12 at least by means of a finger in an arrangement of the printing bed positioned in the insertion cavity 22. Such a grip recess 45 therefore simplifies the manual handling of the printing bed 12, in particular for inserting or removing the printing bed 12 into or from the insertion cavity 22. The grip recess 45 can advantageously be designed as an indentation in a side wall 26 of the insertion cavity 22.

FIGS. 15 to 20 show a workpiece carrier 10 according to yet a further embodiment of the present invention. In the embodiment according to FIGS. 15 to 20, the support structure 16 is designed for receiving a plurality of printing beds 12. In particular, the support structure 16 has a plurality of insertion cavities 22 for a plurality of printing beds 12, wherein a printing bed 12 can be embedded and/or fastened in each insertion cavity 22.

Only one printing bed 12 is illustrated in each case in FIGS. 15 and 16, wherein the three further insertion cavities 22 are illustrated without a printing bed 12 arranged therein. It goes without saying that a single printing bed 12 can be arranged and fastened in each insertion cavity 22, with the result that a total of a plurality of printing beds 12 formed separately from one another can be arranged and/or fastened on the support structure 16, in particular a total of four printing beds 12 formed separately. Each of the insertion cavities 22 is delimited at least in sections by a support base 18 of the support structure 16. Side walls 26, by which the insertion cavities 22 are delimited, are likewise provided. The side walls 26 extending through the center of the support structure 16 can in each case delimit two adjacent insertion cavities 22 with respect to one another.

In the embodiment according to FIGS. 15 to 20, the respective printing bed 12 is also fixedly clamped to the support structure 16 and/or within the insertion cavity 22 by at least one spring device 46, in particular is clamped and/or tensioned laterally against at least one stop 20 or against a side wall 26 of the respective insertion cavity 22 and/or against a side projection 27 of a side wall 26 of the insertion cavity 22. The spring device 46 can in this case be tensioned and/or released in a tool-free manner. In particular, the spring device 46 can have an actuating element 48, as illustrated in more detail in FIG. 20, by means of which an operator can release the clamped state of the printing bed 12 in the insertion cavity 22. For this purpose, the actuating element 48 can be moved away from the printing bed 12 and an engagement on the printing bed 12 can thus be released.

In a plan view of the printing bed 12, a tensioning force of the spring device 48 can act diagonally or obliquely on the respective printing bed 12 and/or extend diagonally or obliquely through the respective printing bed 12. Such a force profile, which is oblique in a plan view, through the respective printing bed 12 can in particular extend at an angle of more than 90° or less than 90° relative to a side edge 50—in a plan view of the printing bed 12—of the printing bed 12.

For this purpose, as illustrated in more detail in FIGS. 15, 16 and 20, the respective spring device 46 can act laterally on a corner region 52 and/or on a corner surface 54 of the printing bed 12. The printing bed 12 can have at least one flattened corner region 52, as can be seen by way of example from FIG. 20. Likewise, the spring device 46 or the actuating element 48 can have a cutout 56 for the contact-free and/or load-free reception of a—not illustrated in more detail in FIG. 20—corner or edge or corner edge of the printing bed 12.

Furthermore, the spring device 46 according to FIG. 20 can be designed for receiving a flattened corner region 52 or for receiving a flattened corner edge of the printing bed 12. For this purpose, the spring device 46 or the actuating element 48 can have a contact surface 58 shaped correspondingly to a flattened corner region 52 and/or to a flattened corner edge.

Within the meaning of the present invention, corner surfaces 54 of the printing bed 12 can be side surface sections of the printing bed 12 that are close to the corners and extend between the upper side 34 and the underside 42 of the printing bed 12 and are adjacent to a corner or corner edge. Flattened corner edges or flattened edges of a corner region 52 can for their part form a corner surface 54 which extends between two side surfaces 40 or between two further corner surfaces 54 of the printing bed 12 and at the same time between an upper side 34 and underside 42 of the printing bed 12.

It can furthermore be seen from FIGS. 15, 16 and 17 that the respective support base 18 can have interruptions 60. A free space can therefore form below the respective interruptions 60. In a configuration with such interruptions, the respective printing bed 12 therefore does not lie over the full area, but a free space is formed below the printing bed 12 at least in the region of the respective interruptions 60.

FIGS. 21 and 22 show a further embodiment of a workpiece carrier 10 according to an embodiment of the present invention. In the embodiment according to FIGS. 21 and 22, the support structure 16 is designed for receiving only one printing bed 12. Therefore, only one insertion cavity 22 is also provided according to FIGS. 21 and 22. In the embodiment according to FIGS. 21 and 22, a spring device 46, by which the printing bed 12 can be fixedly clamped to the support structure 16 and/or within the insertion cavity 22, is likewise provided.

The spring device 46 in turn has an actuating element 48, which is guided as a corner slide within a guide 62 of the support structure 16. The actuating element 48 can be under pretension. Such a pretension can be generated, for example, by a helical spring 64. In the embodiment according to FIGS. 21 and 22, the spring device 46 or the actuating element 48 of the spring device 46 can also be provided with a cutout 56. The cutout 56 can in turn be designed for the contact-free or load-free reception of a corner 65 or edge 66, illustrated in more detail in FIG. 22, of the printing bed 12. The edge 66 can be, in particular, a corner edge or edge of a corner region 52 of the printing bed 12.

In the embodiment according to FIGS. 22 and 21, the spring device 46 can also be tensioned and/or released in a tool-free manner. Consequently, an operator can actuate the spring device 46 without tools and thus clamp or restrain the printing bed 12 within the insertion cavity 22 and also remove it from the insertion cavity 22 of the support structure 16 again free of tool use.

FIG. 23 shows a further embodiment of a workpiece carrier according to the present invention. In the embodiment according to FIG. 23, the printing bed 12 is held down and/or fixedly clamped to the support structure 16 and/or within the insertion cavity 22 by at least one hold-down device 68. The hold-down device 68 can preferably be fixedly screwed to the support structure 16. In this case, the hold-down device 68 can engage in a shaped portion 70 of the printing bed 12 shaped correspondingly to the hold-down device 68. The upper side of the hold-down device 68 can therefore terminate flush with the printing surface 14 of the printing bed 12. Likewise, the upper side of the hold-down device 68 can terminate flush with surface sections 24 on the upper side of the support structure 16.

The hold-down device 68 can be designed, for example, as a hold-down disc. For the tensioning and/or releasing of the printing bed 12 in the case of an embodiment according to FIG. 23, a tool use can therefore be necessary. The clamping and/or removal of the printing bed 12 from the insertion cavity 22 is, with this embodiment, therefore undertaken in a tool-based manner.

The hold-down device 68 can form a floating bearing in lateral directions of the printing bed 12.

Furthermore, the printing bed 12 can be fastened to the support structure 16 via a screw connection 71 or via a plurality of screw connections 71. The screw connection 71 can form a fixed mounting in lateral directions of the printing bed. Consequently, the printing bed 12 can be fastened to the support structure 16 by a fixed-floating bearing arrangement.

In the embodiments according to 1 to 23 described above, the printing bed 12 can be formed at least in sections from a material which differs from a material of the support structure 16. The support structure 16 can be formed at least in sections from a metal material, in particular a light metal material. Particularly preferably, the support structure 16 can be formed from an aluminium material. The support structure 16 according to the embodiments described above can be in particular a milled component, particularly preferably a milled component made from an aluminium material.

Alternatively, the support structure 16 can also be formed from a titanium material and/or from a steel material. Furthermore, there is the possibility of the support structure 16 itself being produced from a plurality of materials. For example, the support base 18 of the support structure 16 can be formed at least in sections from a material which differs from a material of at least one further portion of the support structure 16, in particular from a material of the frame portion 28 of the support structure 16.

It is likewise possible for at least one portion of the support base 18 and a further portion of the support structure 16, in particular the frame portion 28 of the support structure 16, to be formed from an identical material.

The support base 18 can initially be formed in sections from a steel sheet. Such a support base 18 made from steel sheet can preferably be connected to a frame section 28 made from an aluminium material. It is likewise possible for the support base 18 to be formed at least in sections from a light metal material, in particular from an aluminium material and/or from a titanium material. In this case, the support base 18 can advantageously be formed from an identical material to the frame section 28 and/or be formed integrally with the frame section 28.

The printing bed 12 can be formed at least in sections from a titanium material and/or from a glass material and/or from a steel material, in particular a steel sheet, and/or from a magnetic steel. It is likewise possible for the printing bed 12 to be formed at least in sections from a ceramic material and/or from a sintered material.

In the embodiments according to FIGS. 1 to 23 described above, the printing bed 12 can be released non-destructively from the support structure 16 or can be removed from the respective insertion cavity 22. In the embodiments according to FIGS. 1 to 8 and 15 to 22, the printing bed 12 can additionally be released tool-free from the support structure 16 or can be removed from the respective insertion cavity 22. Such a tool-free removal or such a tool-free release can take place exclusively by manual handling and/or actuation. By contrast, in the embodiments according to FIGS. 9 to 14 and 23, a tool-based releasability or removability of the printing bed 12 from the support structure 16 is provided.

The fastening of the printing bed 12 to the support structure 16 can be provided by means of a floating mounting on the support structure 16 and/or within the insertion cavity 22. Such a floating mounting can be provided in particular in order to compensate for temperature-induced expansion behavior relative to the support structure 16. Alternatively, the printing bed 12 can also be fastened to the respective support structure 16 and/or within the insertion cavity 22 in a play-free or substantially play-free manner.

Insofar as compensation of temperature-induced expansion behavior is mentioned here, the expansion behavior is intended to be meant in lateral directions, that is to say along a plane formed by the printing surface 14.

The above-described workpiece carriers 10 according to FIGS. 1 to 23, in particular the support structure 16 together with the printing bed 12 fastened thereto, can be designed for temporary positioning within a printing device, which printing device will be described in more detail below, or also for temporary fastening and/or for temporary clamping to a conveying vehicle of a 3D screen printing machine, which conveying vehicle will likewise be described in more detail below.

The support structure 16 can have predefined contact surfaces 72 for fixing and/or for clamping within a conveying vehicle. The predefined contact surfaces 72 are suitable in particular for clamping in a workpiece carrier mounting of a conveyor vehicle. In a particularly preferred manner, the support structure 16 can have more than two or more than three or three predefined contact surfaces 72 for clamping in a workpiece carrier mounting. The contact surfaces 72 can be formed on an outer circumferential surface of the support structure 16 or of the frame section 28 of the support structure 16. Preferably, at least two contact surfaces 72 can be formed on opposite sides of the support structure 16. Likewise, preferably at least two contact surfaces 72 can be formed on the same side of the support structure 16. In this case, the predefined contact surfaces 72 can be formed inclined with respect to adjacent sections of the outer circumferential surface 74. Correspondingly shaped contact surfaces of the workpiece carrier mounting of the respective conveyor vehicle can be brought into contact with contact surfaces 72 inclined in this way and ensure secure fixing of the workpiece carrier 10.

Reference is made below to FIGS. 24 to 37. FIGS. 24 to 29 show various views of a device 100 according to the invention for producing three-dimensional screen-printed workpieces which are not illustrated in any more detail here. In FIGS. 30 to 36, a part of a printing device 102 of a device 100 for producing three-dimensional screen-printed workpieces is illustrated in different views. In this case, the printing device 102 without a workpiece carrier 10 arranged thereon or therein is shown in FIGS. 30 to 33. In FIGS. 34 to 36, the printing device 102 according to FIGS. 30 to 33 with a workpiece carrier 10 arranged thereon is illustrated. FIG. 37 shows a further perspective view of a printing device 102 without a workpiece carrier arranged thereon.

In detail, FIG. 24 shows a perspective view of a device 100 for producing three-dimensional screen-printed workpieces according to an embodiment of the present invention. FIG. 25 shows a plan view of the device 100 of FIG. 24. The device 100 can be in particular a 3D screen printing machine, particularly preferably a 3D screen printing machine for producing medicaments or pharmaceutical products, in particular in the form of tablets.

The device 100 has at least one printing device 102 for the layerwise production of at least one screen-printed workpiece which is not illustrated in any more detail here in at least one printing operation or a plurality of printing operations. In the embodiments according to FIGS. 24 and 25, the device 100 has two printing devices 102. Furthermore, the device 100 has at least one transport device 104 for the automated transport of at least one screen-printed workpiece and/or of a workpiece carrier 10 towards and/or away from the printing device 102.

FIG. 26 is a perspective view of the device 100 according to FIG. 24. For better clarity and illustration, the transport device 104 is illustrated in the open state, in particular without housings and without frames. FIG. 27 shows a plan view of the device 100 according to FIG. 3.

FIG. 28 shows a perspective view of the device 100 according to FIGS. 24 to 27, wherein, for better clarity and illustration, the printing devices 102 are illustrated in the open state, in particular without housings. FIG. 29 shows a plan view of the device 100 according to FIG. 28.

The transport device 104 can have at least one transport rail and a conveying vehicle 105 which is arranged movably on the transport rail and has at least one workpiece carrier 10 according to the present invention.

Only a part of the printing device 102 from FIGS. 24 to 29 is shown in FIGS. 30 to 36. The printing device 102 has a printing superstructure 106—as shown in FIGS. 28 and 37—and also a printing table plate 108 on which a workpiece carrier 10 can be temporarily positioned for carrying out a printing operation. The printing superstructure can have a printing screen 114, as can be seen in FIG. 37.

The arrangement of a workpiece carrier 10 on the printing table plate 108 can be seen from FIG. 34. Furthermore, a position detection device 110 is also shown in FIGS. 30 to 35. The position detection device 110 can be designed and/or configured for detecting the position of the printing bed 12 of a workpiece carrier 10 positioned on the printing table plate 108 or contacted on the underside by the printing table plate 108, which will be discussed in detail below.

According to the illustration in FIGS. 30 to 34, the printing device 102 can also be equipped with a position detection device 112 for a printing screen 114. The position detection device 112 can furthermore also be designed and/or configured for detecting the position of a printing bed 12 of a workpiece carrier 10 arranged on the printing table 108.

Further component parts of the printing device 102 are not illustrated in any more detail in FIGS. 30 to 35 for reasons of clarity.

For a position detection in question here by a position detection device 110 and/or 112, in the case of a workpiece carrier 10 according to the present invention the position and/or alignment of the printing bed 12 can be detectable from a side 76 of the support structure 18 facing away from the printing bed 12. The side 76 of the support structure 18 facing away from the printing bed 12 is an underside of the support structure 18.

As in the embodiments of the workpiece carrier 10 according to FIGS. 1 and 3, the support structure 16 can have at least one viewing region 78 for this purpose. The position and/or alignment of the printing bed 12 can be optically detectable at least through a viewing region 78 of the support structure 16. Such a viewing region 78 of the support structure 16 can furthermore be seen in more detail from FIG. 35 and also from the detail view in FIG. 36.

The viewing region 78 can particularly preferably be designed as a viewing opening 80. It is likewise possible for the viewing region 78 to be formed at least in sections from a transparent and/or translucent material. Adjacent to the viewing region 78, the support structure 16 can be formed at least in sections by a material which is impermeable to light. In a workpiece carrier 10, as shown for example in FIGS. 1, 3 and 35 and 36, the support structure 16 can have a plurality of viewing regions 78 formed independently of one another, in particular two viewing regions 78, between which the support structure 16 is formed at least in sections from a material which is impermeable to light.

At least one corner 82 and/or edge 84 of the printing bed 12 can be optically detectable through a viewing region 78 of the support structure 16. In this case, the at least one viewing region 78 of the support structure 16 can be partially covered in plan view—as shown in FIGS. 35 and 36—by a corner region 86 and/or edge region 88 of the printing bed 12. By means of such a partial covering, optical detection of the respective corner 82 or edge 84 or of the contour profile of the printing bed 12 can be detected well. For partial or incomplete covering of the viewing region 78, in the case of optical detection, a differentiation can namely be made between regions which are covered by the printing bed 12 and those regions which remain free and are therefore not covered. This results in a high detection quality and therefore precise position detection of the printing bed 12.

Direct optical detection of the printing bed 12 by means of a position detection device 110 and/or 112 is advantageous in particular in the case of a floating mounting of the printing bed 12 on the support structure 16. Displacements or temperature-induced expansions of the printing bed 12 relative to the support structure 16 have no influence on the detection accuracy in the case of direct optical detection of the printing bed 12.

According to a still further preferred embodiment, the support structure 16 and/or the printing bed 12 of the workpiece carrier 10 can be provided with at least one marking 90 for position detection. In particular, the support structure 16 and/or the printing bed 12 can have a plurality of markings 90 for position detection. Such a marking 90 can be an optically detectable marking and/or reference bores. In the embodiments according to FIGS. 1 to 23, in each case a plurality of markings 90 in the form of a reference bore is provided in the support structure 16. Such a marking provided as a reference bore can likewise also be provided in the printing bed 12, which is not illustrated in any more detail here, however.

The position and/or alignment of the support structure 16 can be detectable via the marking 90. The marking 90 can be provided in a particularly preferred manner by a through-bore reference bore in the support structure 16. In this manner, the marking 90 of the support structure 16 can also be arranged on a side 76 of the support structure 16 facing away from the printing bed 12 and can be detectable starting from this side 76. By means of the position detection of the support structure 16, in particular via a marking 90, a further improved process reliability can be achieved. In particular, there is the possibility that, in the case of a play-free mounting of the printing bed 12 relative to the support structure 16, a conclusion can be drawn via a position detection of the support structure 16 as to the position or position and/or alignment of the printing bed 12. In this case, direct optical detection of the respective printing bed 12 is at least not absolutely necessary, but a position detection of the support structure 16 and, via this, a conclusion as to the position of the printing bed 12 can be undertaken with sufficiently high accuracy.

According to a further preferred configuration—not illustrated in any more detail here—at least one marking of the printing bed 12 can be optically detectable starting from a side 76 of the support structure 16 facing away from the printing bed 12. For example, a marking of the printing bed 12 can be arranged on a side 76 of the printing bed 12 that faces the support structure 16. In particular, a marking of the printing bed 12 can be arranged in a viewing region 78 of the support structure 16 or above a viewing region 78 of the support structure 16, such that it can be optically detected starting from a side 76 of the support structure 16 facing away from the printing bed 12. In this way, the direct optical detection of the printing bed 12 can be further improved from a side 76 of the support structure 16 facing away from the printing bed 12.

Additionally or alternatively, the support structure 16 can be formed at least in sections or completely from a transparent and/or translucent material. For example, the support structure 16 can consist at least in sections of a glass and/or plastic material. In this case, the position and/or alignment of the printing bed 12 can be optically detectable at least through a transparent and/or translucent portion of the support structure 16.

The mode of operation of the position detection devices 110 and 112 will be discussed in more detail below with reference to FIGS. 30 to 37. As already mentioned above, a part of a printing device 102, namely the printing table plate 108 and the position detection devices 110 and 112, is illustrated in FIGS. 30 to 33. The remaining components of the printing device 102 are not illustrated in any more detail in FIGS. 30 to 36 for reasons of clarity.

No workpiece carrier is arranged on the printing table plate 108 in the corridors 30 to 33. However, it goes without saying that a workpiece carrier 10 according to an embodiment of the present invention can be temporarily positioned within the printing device 102, in particular on the printing table plate 108, for carrying out a printing operation. In particular, the respective workpiece carrier 10 can be contactable on the underside by the printing table plate 108.

In FIGS. 33 to 36, a workpiece carrier 10 according to an embodiment of the present invention is located on the printing table plate 108. In particular, in the perspective illustration according to FIG. 34, a workpiece carrier 10 according to the embodiment in FIG. 3 is provided, namely with fixing of the printing bed 12 by means of adhesive tapes 32. In the illustration according to FIGS. 35 and 36, the workpiece carrier according to FIGS. 1 and 2 can be formed.

The printing table plate 108 can be designed to fix the workpiece carrier 10 for carrying out a printing operation when contacting on the underside.

Furthermore, the position detection device 110 is configured to detect the position and/or alignment of the printing bed 12 and/or of the support structure 16 of the workpiece carrier 10 arranged on the printing table plate 108 in space and/or relative to a printing superstructure 106 of the printing device 102—as shown in FIG. 28—and/or relative to a printing screen 114—as illustrated in any more detail in FIG. 37. Additionally or alternatively, the position detection device 110 can be configured to detect the position and/or alignment of the printing bed 12 and/or of the support structure 16 of a workpiece carrier 10 arranged on the printing table plate 108 relative to the printing table plate 108 of the printing device 102 arranged thereunder. Furthermore, the position detection device 110 can also be configured to detect the position and/or alignment of the respective printing bed 12 relative to the support structure 16 of the respective workpiece carrier 10 arranged thereunder.

As can be seen from FIGS. 30 to 36, when the workpiece carrier 10 is arranged on the printing table plate 108, the viewing region 78 can be arranged within the illumination field 116 of the position detection device 110 indicated here in a cylindrical manner. Furthermore, the viewing region 117 of the position detection device 110 can be arranged within the illumination field 116.

The position detection device 110 can have at least one camera 118 or a plurality of cameras 118. The at least one camera 118 can preferably be arranged below the printing table plate 108. The viewing region 117 can be, in particular, the viewing region 117 of the respective camera 118. A plurality of cameras 118 can jointly form a position detection device 110 or a plurality of position detection devices 110 are formed in each case by a camera 118.

As can furthermore be seen from FIGS. 35 to 36, the cameras 118 are not only arranged below the printing table plate 108, but are also aligned laterally past the printing table plate 108. In this way, the respective illumination field 116 and also the respective viewing region 117 of the camera 118 can be aligned with the corresponding viewing region 78 of the workpiece carrier 10 in a particularly space-saving manner.

Therefore, in an arrangement according to FIGS. 34 to 36, the printing bed 12 of the workpiece carrier 10 can be detected directly via the respective camera 118 in the viewing region 78 by the support structure 16. Due to the partial covering of the viewing region 78 by the printing bed 12, the respective corner region 86 of the printing bed 12 can be detected by the respective camera 118.

As can furthermore be seen from FIG. 37, a position detection device 110 is also suitable for detecting a printing screen 114 and/or the printing superstructure 106. The illumination field 116 of the position detection device 110 or of the camera 118 is also indicated schematically in FIG. 37.

In this case, optical detection of a printing screen 114 and/or of the printing superstructure 106 can also be undertaken by means of the position detection device 110 through the support structure 16 of a workpiece carrier 10. In particular, optical detection of a printing screen 114 and/or of the printing superstructure 106 can be undertaken by means of the position detection device 110 through a viewing region 78 or through a viewing window 80 of the support structure 16. This applies in particular to embodiments of a workpiece carrier 10 according to which the respective viewing region 78 of the support structure 16 is not covered by the printing bed 12, as for example in FIGS. 4 to 14.

Furthermore, the position detection device 112 can also be formed by a camera 120. The position detection device 112 can likewise be formed by a plurality of cameras 120 or a plurality of position detection devices 112 can be provided, which in each case have a camera 120. The illumination field of the position detection device 112 or of the camera 120 is denoted by 122. In addition, the position detection device 112 or the camera 120 has a viewing region 123.

The cameras 120 are arranged below the printing table plate 108 and the illumination field 122 and also the viewing region 123 of the respective position detection device 112 or camera 120 is directed at a viewing opening 124 in the printing table plate 108. Consequently, the position detection device 112 is designed or arranged for detecting the position through the printing table plate 108.

The position detection device 112 or the camera 120 is therefore suitable for detecting the position of a printing bed 12 insofar as the respective support structure 16 is equipped with viewing regions 78 or at least one viewing region 78, for example, when the workpiece carrier 10 is arranged on the printing table plate 108 in the region of the viewing openings 124 of the printing table plate 108. This can be advantageous, for example, if it is a relatively small printing bed 12, as shown, for example, in the embodiment according to FIGS. 4 to 14.

It is likewise possible for a marking of a printing bed 12 to be detected by the position detection device 112 through the viewing opening 124, which can also be advantageous in the case of relatively large printing beds 12. It is therefore not absolutely necessary for the viewing opening 124 of the printing table plate 108 to be partially covered by a corner region 86 and/or edge region 88 of a printing bed 12.

Rather, the viewing opening 124 can also be completely covered by a printing bed 12 and a marking, not illustrated in any more detail here, of a printing bed 12 can be detected on the underside through the viewing opening 124.

As can furthermore be seen from FIG. 37, the position detection device 112 or the camera 120 is also suitable for detecting the position of a printing screen 114 or of a printing superstructure 106. The illumination field 122 of the position detection device 112 is also shown in FIG. 37 and extends through the printing table plate 108 in the region of the viewing openings 124. The respective viewing region 123 is also arranged within the illumination field 122. In particular, smaller printing screens 114 can be detected by the position detection device 112.

The viewing opening 124 of the printing table plate 108 can generally be a viewing region 126 of the printing table plate 108. It goes without saying that the viewing region 126 of the printing table plate 108 can also be partially covered in plan view by a corner region 86 and/or edge region 88 of the printing bed 12—not illustrated in any more detail here—of a workpiece carrier 10 positioned on the printing table plate 108.

The position detection device 112 can in this case be configured to detect the covering of at least one viewing region 126 in the printing table plate 108 by the printing bed 12 and/or by a support structure 16 of a workpiece carrier 10 positioned within the printing device 102.

The printing table plate can furthermore be designed for fixing a workpiece carrier 10 by means of negative pressure. For this purpose, the printing table plate 108 can have at least one suction opening 128 or a plurality of suction openings 128. Negative pressure can be applied to the underside 76 of a workpiece carrier 10 through the suction openings. In particular, negative pressure can be applied to an underside 42 of a printing bed 12 of the workpiece carrier 10 via the suction openings 128 via at least one suction opening 36 of the support structure 16 of the workpiece carrier 10. Fixing of the workpiece carrier 10 or of the printing bed 12 by means of negative pressure ensures a high degree of fastening reliability and therefore a reliable and precise printing operation in the fixed position of the workpiece carrier 10 or of the printing bed 12.

In a further preferred manner, an adjusting device, not illustrated in any more detail here, of the printing table plate 108 and/or an adjusting device, likewise not illustrated in any more detail here, of the printing superstructure 106 and/or of the printing screen 114 can be configured to undertake position and/or alignment settings as a function of position detection by a position detection device 110 and/or 112.

Furthermore, the printing device 102 can be configured to set the relative position and/or relative alignment between the printing bed 12 of the respective workpiece carrier 10 positioned on the printing table plate 108 and the printing superstructure 106 of the printing device 102 and/or the printing screen 114 of the printing device 102 as a function of position detection of the printing bed 12 by the position detection device 110 and/or 112.

Additionally or alternatively, the printing device 102 can be configured to set the relative position and/or relative alignment between the support structure 16 of the workpiece carrier 10 and the printing screen 114 as a function of position detection of the printing bed 12 and/or of the support structure 16 of a workpiece carrier 10 positioned within the printing device 102 or on the printing table plate 108 by the position detection device 110 and/or 112.

The printing device 108 can furthermore be configured to set the relative position and/or relative alignment between the printing table plate 108 and the printing superstructure 106 and/or between the printing table plate 108 and the printing screen 114, in particular as a function of the position detection of the printing bed 12 and/or of the support structure 16 of a workpiece carrier 10 positioned within the printing device 102 and/or as a function of the position detection of the printing screen 114 and/or of the printing table plate 108 by the position detection device 110 and/or 112.

It goes without saying here that the position detection device 110 and/or 112 can also be designed for detecting the position of the printing table plate 108.

Furthermore, the printing device 102 can be configured to undertake a printing operation immediately following the position detection of the printing bed 12 and/or following the setting of the relative position and/or the relative alignment between the printing bed 12 and the printing screen 114 or the printing superstructure 108, in particular without further transport of the respective workpiece carrier 10.

A workpiece carrier 10 described above or also a device 100 for producing three-dimensional screen-printed workpieces 11 is suitable in particular for carrying out a method for producing three-dimensional screen-printed workpieces 11. For this purpose, at least one screen-printed workpiece 11 is produced layerwise in a plurality of printing operations in the printing device 102. In this case, for carrying out a printing operation, a workpiece carrier 10 according to the preceding description is temporarily arranged within the printing device 102 and a position detection of the printing bed 12 of the workpiece carrier 10 is undertaken via a position detection device 110 and/or 112 of the printing device 102.

In particular, pharmaceutical products or medicaments, preferably in tablet form, can be produced with little effort and a high degree of flexibility by means of such a method.

### LIST OF REFERENCE SIGNS

10 workpiece carrier
11 screen-printed workpiece
12 printing bed
14 printing surface
16 support structure
18 support base
20 stop
22 insertion cavity
24 surface section
26 side wall
27 side projection
28 frame section
29 clearance section
30 magnetic film
32 adhesive tape
34 upper side of the printing bed 12
36 suction opening
38 spring device
40 side surface of the printing bed 12
42 underside of the printing bed 12
44 tool
45 grip recess
46 spring device
48 actuating element
50 side edge of the printing bed 12
52 corner region of the printing bed 12
54 corner surface
56 recess
58 contact surface of the spring device 46
60 interruption of the support base 18
62 guide of the support structure 16
64 helical spring
65 corner of the printing bed 12
66 corner edge of the printing bed 12
68 hold-down element
70 shaped portion
71 screw connection
72 contact surface of the support structure 16
74 outer circumferential surface of the support structure 16
76 underside of the support structure 16
78 viewing region
80 viewing opening
82 corner of the printing bed 12
84 edge of the printing bed 12
86 corner region of the printing bed 12
88 edge region of the printing bed 12
90 marking
100 apparatus for producing three-dimensional screen-printed workpieces
102 printing device
104 transport device
105 conveying vehicle
106 printing superstructure
108 printing table plate
110 position detection device
112 position detection device
114 printing screen
116 illumination field
117 viewing region
118 camera
120 camera
122 illumination field
123 viewing region
124 viewing opening of the printing table plate 108
126 viewing region of the printing table plate 108
128 suction opening of the printing table plate 108

1. A workpiece carrier (10) comprising:
at least one printing bed (12) which has a printing surface (14) to be printed on; and
a support structure (16) which supports the printing bed (12) and is formed separately from the printing bed (12),
wherein the support structure (16) has a support base (18) and at least one stop (20) for the printing bed (12),
wherein the printing bed (12) is arranged on the support base (18), and
wherein, in the position arranged on the support base (18), the printing bed (12) can be brought to bear against the stop (20) in at least one lateral direction.

2. The workpiece carrier (10) according to claim 1, wherein the printing bed (12) is fastened to the support structure (16), and/or wherein, in the position arranged on the support base (18) and fastened to the support structure (16), the printing bed (12) bears in a lateral direction against the at least one stop (20) of the support structure (16).

3.-5. (canceled)

6. The workpiece carrier (10) according to claim 1, wherein the height of the stop (20) relative to the support base (18) in a thickness direction of the support structure (16) and/or in a thickness direction of the printing bed (12) is dimensioned to be less than or equal to the thickness of the printing bed (12).

7. (canceled)

8. (canceled)

9. The workpiece carrier (10) according to claim 1, wherein the support structure (16) has an insertion cavity (22) for the printing bed (12), wherein the printing bed (12) is at least partially embedded in the insertion cavity (22).

10.-15. (canceled)

16. The workpiece carrier (10) according to claim 1, wherein the printing bed (12) is at least partially formed from a material which differs from a material of the support structure (16), and/or in that the printing bed (12) is at least partially formed from a material having a constitution and/or composition which differs from the constitution and/or composition of a material of the support structure (16).

17.-32. (canceled)

33. The workpiece carrier (10) according to claim 1, wherein the printing bed (12) is releasable non-destructively and/or tool-free from the support structure (16).

34. The workpiece carrier (10) according to claim 1, wherein the printing bed (12) is fastened to the support structure (16) in a floating manner, and/or wherein the printing bed (12) is fastened to the support structure (16) in a play-free or substantially play-free manner.

35. The workpiece carrier (10) according to claim 1, wherein the printing bed (12) is fastened in a force-fitting and/or form-fitting and/or material-bonded manner to the support structure (16).

36.-51. (canceled)

52. The workpiece carrier (10) according to claim 1, wherein the support base (18) has at least one through-bore suction opening (36), for applying a negative pressure to the printing bed (12) and/or for suctioning the underside of the printing bed (12) for temporary fixing within a printing device (102) of a 3D screen printing machine.

53.-60. (canceled)

61. The workpiece carrier (10) according to claim 1, wherein a separating layer is arranged between the printing bed (12) and the support structure (16), and/or in that the separating layer is arranged and/or designed to avoid and/or to reduce the heat transfer between the printing bed (12) and the support structure (16).

62.-66. (canceled)

67. The workpiece carrier (10) according to claim 1, wherein the support base (18) has interruptions (60) and/or openings, and/or wherein the support base (18) has support webs for the partial support of the printing bed (12), and/or wherein a free space is formed at least partially between the support base (18) and the printing bed (12) and/or on an underside (42) of the printing bed (12) that faces the support base (18) and/or at least one free space defined by an interruption (60) of the support base (18).

68.-74. (canceled)

75. A support structure (16), comprising: a support base (18) for arranging a printing bed (12) which has a printing surface (14) to be printed on, and at least one stop (20) for the printing bed (12) arranged on the support base (18), wherein a printing bed (12) arranged on the support base (18) can be brought to bear against the stop (20) in at least one lateral direction.

76. (canceled)

77. An apparatus (100) for producing three-dimensional screen-printed workpieces, comprising:
a printing device (102) for the layer-wise production of at least one screen-printed workpiece in a plurality of printing operations; and
a transport device (104) for the automated transport of at least one workpiece carrier (10) according to claim 1 towards and/or away from the printing device (102),
wherein the transport device (104) has at least one transport rail and a conveying vehicle (105) which is arranged movably on the transport rail and has the at least one workpiece carrier (10).

78. A method for producing a three-dimensional screen-printed workpiece, in which the at least one screen-printed workpiece is produced layer-wise on the workpiece carrier (10) according to claim 1 in a plurality of printing operations by means of a printing device (102), and in which method the workpiece carrier (10) with the at least one screen-printed workpiece is transported in an automated manner towards and/or away from the printing device (102) by means of a transport device (104).

79. (canceled)

80. A pharmaceutical product produced using the method according to claim 78.

81. The pharmaceutical product of claim 80, wherein the pharmaceutical product is a tablet.

82. The workpiece carrier (10) according to claim 9, wherein the printing bed (12) is removable from the insertion cavity (22) non-destructively and/or tool-free by manual handling and/or actuation.

83. The workpiece carrier (10) according to claim 9, wherein the printing bed (12) is fastened within the insertion cavity (22) in a play-free or substantially play-free manner.

84. The workpiece carrier (10) according to claim 9, wherein the printing bed (12) is fastened in a force-fitting and/or form-fitting and/or material-bonded manner within the insertion cavity (22) in a position bearing in a lateral direction against at least one stop (20) or against a plurality of stops (20).
